(19) United States
(12) Patent Application Publication
(10) Pub. No.: US 2025/0145736 A1
(43) Pub. Date: May 8, 2025

(54) RESISTANT DEXTRINS AND METHODS OF MAKING RESISTANT DEXTRINS

(71) Applicant: CARGILL, INCORPORATED, Wayzata, MN (US)

(72) Inventors: Abdelfattah Bensouissi, Braine-l'Alleud (BE); Isabelle Déléris, Evere (BE); Marcello Murru, Quartu Sant'Elena (IT); Bruno Frédéric Stengel, Brussels (BE); Nick Vaes, Berlaar (BE)

(73) Assignee: CARGILL, INCORPORATED, Wayzata, MN (US)

(21) Appl. No.: 18/837,288

(22) PCT Filed: Feb. 17, 2023
(86) PCT No.: PCT/US2023/062803

§ 371 Date: Aug. 9, 2024

(30) Foreign Application Priority Data
Feb. 17, 2022 (EP) 22157201.9

(51) Int. Cl. C08B 37/00; A23G 1/40; A23G 3/42

(52) U.S. Cl. CPC C08B 37/0009; A23G 1/40; A23G 3/42; A23G 2200/06

(57) ABSTRACT

The present invention relates generally to resistant dextrins and methods of making resistant dextrins. In particular, the present invention relates to resistant dextrins having physical properties desirable in, at least, products for the food and beverage industry. In particular, the present invention relates to methods of making the resistant dextrins having physical properties desirable in, at least, products for the food and beverage industry.

### CROSS-REFERENCE TO RELATED APPLICATIONS

This application claims the benefit of European Patent Application No. 22157201.9, filed Feb. 17, 2022, which is incorporated by reference herein in its entirety.

### FIELD OF THE INVENTION

The present invention relates to resistant dextrins and methods of making resistant dextrins. In particular, the present invention relates to resistant dextrins having physical properties desirable in, at least, food and beverage products. In particular, the present invention relates to methods of making the resistant dextrins having physical properties desirable in, at least, food and beverage products.

### BACKGROUND OF THE INVENTION

Carbohydrates are found in an array of food and beverage products, such as processed cereal, soft drinks, bread, beans, potatoes, corn, and pasta. The carbohydrates present in the food and beverage products come in a variety of forms, the most common of which are sugars, fibers and starches. The fibers found in food products are commonly known as dietary fibers, which are present in, but not limited to being present in, vegetables, fruits, whole grains and legumes. Dietary fibers are the indigestible part of food and beverages originating from plants and typically pass relatively intact through the digestive system and out of the consumer's body.

Dietary fibers can be split into two forms: soluble dietary fibers and insoluble dietary fibers. Most food and beverage products, especially those originating from plants, contain both soluble and insoluble dietary fibers, in varying amounts. Soluble dietary fibers dissolve in water and may form a gel-like material. Examples of fruits, grains and vegetables containing soluble dietary fibers include, but are not limited to, oats, peas, beans, apples, citrus fruits, carrots and barley. Insoluble dietary fibers are traditionally used in food and beverage products to provide desirable characteristics, such as nutrition, texture and/or mouthfeel. Insoluble dietary fibers promote the movement of material through a consumer's digestive system as well as increasing stool bulk. Examples of food and beverage products containing insoluble dietary fibers include, but are not limited to, whole-wheat flour, wheat bran, nuts, beans and vegetables such as cauliflower, green beans and potatoes.

There is an interest in developing ingredients that are suitable for use in food products and that are soluble and either nondigestible or only digestible to a limited extent, in order to enhance the dietary fiber content or reduce the caloric content of the food. These ingredients may also have certain health benefits.

Examples of such ingredients and in particular of soluble dietary fibers for use in food and beverage products are described in WO2021081305, WO2021108782, WO2014100539, EP2418947, US2011020496, U.S. Pat. No. 9,200,087, EP561090, WO2019023558, U.S. Pat. No. 9,783,619, WO2011039151, U.S. Pat. Nos. 10,479,812 and 8,445,460.

Soluble dietary fibers can be used to modify the texture, thickness, mouthfeel, body or other physical characteristics of a food or beverage product. An example of soluble dietary fibers is resistant dextrins. Resistant dextrins are formed by a highly controlled partial hydrolysis and re-polymerization of the dextrinization process. Resistant dextrins are short chain glucose polymers typically obtained by high-temperature acidification of starch. The resultant resistant dextrin contains α-1,2 and α-1,3 glycosidic bonds in addition to the existing α-1.4 and α-1,6 glycosidic bonds which are also present in starch. The resistant dextrins also contain reducing terminals that may contain β-1,6 glycosidic bonds. The α-1,2, α-1,3 and α-1,6 glycosidic bonds cannot be decomposed by various digestive enzymes in the human body, and therefore cannot be digested and absorbed by the small intestine after entering the human digestive tract. Hence, resistant dextrins are not digestible, or only digestible to a limited extent, by a human body.

As a consequence of resistant dextrins not being digested in the digestive system, resistant fibers are of interest in products used in food and beverage products. Examples of resistant dextrins used in food and beverage products are described in WO2013015890, AU201100495, U.S. Pat. No. 10,988,550, US20200385494 and EP3409693.

One reason why resistant dextrins are of interest to the food and beverage industry is because resistant dextrins can be used to enhance dietary fiber content and/or reduce the sugar and caloric content of the food or beverage. These modifications are important for the health benefit deriving from the resultant food or beverage product. For example, as a consequence of the resistant dextrin not being absorbed in the small intestine, the resistant dextrin can enter the large intestine and be used by various probiotics as nutrients to achieve various physiological functions of dietary fibers. A second example is that resistant dextrin can also be used to create a feeling of satiety owing to the resistant dextrin not being absorbed, thus resistant dextrin can be used as a good base material in food products for people with obesity. A third example is that resistant dextrin can also be used to replace higher calorie content in food and beverage products, such as food and beverage products that contain a high level of sugar (such as sucrose).

There is a continued need for improved resistant dextrins that can be used in food and/or beverage products.

### SUMMARY OF THE INVENTION

Representative features of the present invention are set out in the following clauses, which stand alone or may be combined, in any combination, with one or more features disclosed in the text of the specification.

The present invention is as set out in the following clauses:
1 A resistant dextrin in particulate form, having:
   a SPAN of at most 2.7; and
   a specific surface area of from 0.05 to 0.20 m²g, as measured by the Brunauer-Emmett-Teller (BET) adsorption method.
2. The resistant dextrin of clause 1, wherein the SPAN is at most 2.15.
3. The resistant dextrin of clause 1 or clause 2, wherein the specific surface area is from 0.10 to 0.18 m²g, as measured by the Brunauer-Emmett-Teller (BET) adsorption method.
4. The resistant dextrin according to any one of clauses 1 to 3, having a dextrose equivalent (DE) of from 5 to 20, or, from 10 to 15, or 12 weight % on a dry solid basis.
5. The resistant dextrin according to any one of clauses 1 to 4, having a 5-hydroxymethylfurfural (HMF) content of at most 5 ppm, or, at most 2.5 ppm, or, at most 1 ppm.
6. The resistant dextrin according to any one of clauses 1 to 5, having a glass transition temperature (Tg) of 70° C. or below when measured at a moisture content of 5% or above.
7. The resistant dextrin according to any one of clauses 1 to 6, having a DP1 and DP2 content, wherein DP1 and DP2 are present at a combined weight % of at most 40 weight %, or, at most 30 weight %, or, at most 20 weight %.
8. The resistant dextrin according to any one of clauses 1 to 7, having:
   a D10 in the range of from 1 to 40 μm, or, from 5 to 30 μm, or, from 10 to 20 μm, or, from 13 to 19 μm; and/or,
   a D50 in the range of from 5 to 100 μm, or, from 10 to 80 μm, or, from 20 to 60 μm, or, from 30 to 50 μm, or, from 35 to 45 μm; and/or,
   a D90 in the range of from 20 to 200 μm, or, from 30 to 150 μm, or, from 40 to 125 μm, or, from 50 to 100 μm, or, from 60 to 90 μm, or, from 70 to 85 μm, or, from 75 to 80 μm.
9. The resistant dextrin according to any one of clauses 1 to 8, having a weight-average molecular weight of from 1000 to 2000 g/mol, or, 1250 to 1750 g/mol.
10. The resistant dextrin according to any one of clauses 1 to 9, wherein the total amount of monosaccharides and disaccharides is at most 25 weight %, or, at most 20 weight %, or, at most 15 weight %, or, at most 12.5 weight %, or, at most 10 weight %, or, at most 5 weight 5%, or, at most 2 weight %, or, at most 1 weight %, or, at most 0.5 weight % on a dry solid basis.
11. The resistant dextrin according to any one of clauses 1 to 10, wherein the resistant dextrin has a substantially spherical morphology: optionally, wherein the resistant dextrin has a substantially spherical morphology and is non-agglomerated.
12. The resistant dextrin according to any one of clauses 1 to 11, wherein the resistant dextrin does not comprise sorbitol.
13. The resistant dextrin according to any one of clauses 1 to 12, having an oil binding capacity (OBC) of from 0.60 to 1.35 g/g: optionally, wherein the OBC is from 0.80 to 1.30 g/g: or, from 1.05 to 1.25 g/g, or 1.12 g/g.
14. The resistant dextrin according to any one of clauses 1 to 13, having a wettability such that 10 g of the resistant dextrin in particulate form fully submerges in 250 ml of water at 25° C. within at most 20 seconds: optionally, wherein the wettability is such that 10 g of the resistant dextrin fully submerges in 250 ml of water at 25° C. within at most 15 seconds, or, at most 10 seconds, or, at most 5 seconds.
15. The resistant dextrin according to any one of clauses 1 to 14, wherein the resistant dextrin is white or near white in colour: optionally, wherein the resistant dextrin has Hunter Lab colorimetric parameters of from 95 to 100 (L): from −1.5 to +1.5 (a); and from 0 to +5 (b): optionally, wherein the Hunter Lab colorimetric parameters are measured on a Chroma-meter CR410.
16. A resistant dextrin in liquid form which, when dried, is the resistant dextrin in particulate form according to any one of clauses 1 to 15.
17. A resistant dextrin in liquid form comprising:
   the resistant dextrin in particulate form according to any one of clauses 1 to 15; and water.
18. A method for making the resistant dextrin in particulate form according to any one of clauses 1 to 15, the method comprising:
   (a) providing a saccharide feed comprising at least 35 weight %, or, at least 45 weight %, or, at least 55 weight % on a dry solid basis of dextrose and/or dextrose oligomers;
   (b) heating the saccharide feed to a temperature of at least 60° C.:
   (c) adding an acidifying catalyst to form an acidic composition;
   (d) heating the acidic composition up to at least 120° C., or, at least 140° C., or at least 180° C., or, at least 190° C.:
   (e) injecting the acidic composition through a first microdevice to react the dextrose and/or dextrose oligomers with the acid catalyst in the presence of water for a time sufficient to produce a first reacted composition wherein at least 60 weight %, or at least 70 weight %, or, at least 80 weight %, or, at least 85 weight % of the dextrose and/or dextrose oligomers have reacted, and wherein the first reacted composition comprises from 60 to 90 weight %, or, from 70 to 80 weight %, or, 75% weight dry solids;
   (f) extracting the water from the first intermediate product (first reacted composition) to obtain a water-depleted composition comprising at least 90 weight %, or, 95 weight %, or, 98 weight % dry solids:
   (g) injecting the water-depleted composition through a second microdevice to react any non-reacted dextrose and/or dextrose oligomers with the acid catalyst at a temperature of at least 160° C., or, 180° C., or, 200° C., or, at least 210° C., or, at least 220° C. for a time sufficient to produce a second reacted composition wherein at least 90 weight %, or, at least 92 weight % of the dextrose and/or dextrose oligomer have reacted, and wherein the second reacted composition comprises from 60 to 80 weight %, or, from 65 to 75 weight %, or, 70 weight % dry solids;
   (h) refining the second reacted composition to form a refined second reacted composition; and/or
   (i) drying the refined second reacted composition to produce the resistant dextrin.
19. The method of clause 18, wherein the microdevice contains one or more of micro mixers, micro heat exchangers and/or micro reactors suitable for the polycondensation of carbohydrates.
20. The method of clause 18 or clause 19, wherein the method further comprises the step of collecting the second reacted composition in a basic solution by allowing the second reacted composition to fall under gravity from the second microdevice into a container containing a basic solution.
21. The method according to any one of clauses 18 to 20, wherein the step of drying the refined second reacted composition is performed by spray drying: optionally, wherein the step of drying the refined second reacted composition is performed for a sufficient amount of time until the resistant dextrin has at most 10 weight % moisture, or, at most 7.5 weight % moisture, or, at most 6 weight % moisture.
22. A composition comprising:
   the resistant dextrin in particulate form according to any one of clauses 1 to 15; and, water.
23. The composition of clause 22, wherein the composition comprises the resistant dextrin in particulate form at from 55 to 98 weight %, or, from 60 to 90 weight %, or, from 65 to 85 weight %, or, from 70 to 80 weight %, or, at 72 weight %.
24. A method of forming a resistant dextrin in liquid form, the method comprising:
   (a) providing a saccharide feed comprising at least 35 weight %, or, at least 45 weight %, or, at least 55 weight % on a dry solid basis of dextrose and/or dextrose oligomers;
   (b) heating the saccharide feed to a temperature of at least 60° C.:
   (c) adding an acidifying catalyst to form an acidic composition;
   (d) heating the acidic composition up to at least 120° C., or, at least 140° C., or at least 180° C., or, at least 190° C.:
   (e) injecting the acidic composition through a first microdevice to react the dextrose and/or dextrose oligomers with the acid catalyst in the presence of water for a time sufficient to produce a first reacted composition wherein at least 60 weight %, or at least 70 weight %, or, at least 80 weight %, or, at least 85 weight % of the dextrose and/or dextrose oligomers have reacted, and wherein the first reacted composition comprises from 60 to 90 weight %, or, from 70 to 80 weight %, or, 75% weight dry solids;
   (f) extracting the water from the first reacted composition to obtain a water-depleted composition comprising at least 90 weight %, or, 95 weight %, or, 98 weight % dry solids;
   (g) injecting the water-depleted composition through a second microdevice to react any non-reacted dextrose and/or dextrose oligomers with the acid catalyst at a temperature of at least 160° C., or, 180° C., or, 200° C., or, at least 210° C., or, at least 220° C. for a time sufficient to produce a second reacted composition wherein at least 90 weight %, or, at least 92 weight % of the dextrose and/or dextrose oligomer have reacted, and wherein the second reacted composition comprises from 60 to 80 weight %, or, from 65 to 75 weight %, or, 70 weight % dry solids; and/or
   (h) refining the second reacted composition to form the resistant dextrin in liquid form.
25. The method of clause 24, wherein the method further comprises the step of:
   (i) drying the resistant dextrin in liquid form to produce a partially dried resistant dextrin in liquid form:
optionally, wherein the partially dried resistant dextrin in liquid form comprises resistant dextrin at from 76 to 86 weight %, or, from 74 to 85 weight %, or, from 75 to 84 weight %, or, from 78 to 82 weight %: the balance at each weight % being essentially water.
26. A resistant dextrin in liquid form obtained, or obtainable, by the method of clause 24 or clause 25.
27. A food product comprising the resistant dextrin in particulate form according to any one of clauses 1 to 15 and/or the resistant dextrin in liquid form according to any one of clauses 16, 17 and/or 26.
28. The food product of clause 27, wherein the resistant dextrin in particulate form and/or liquid form is disposed in a phase of the food product having 10 weight % water or less, or, 7.5 weight % water or less, or, 6 weight % water or less.
29. The food product of clause 28, wherein the resistant dextrin in particulate form and/or liquid form is dispersed in a lipid phase of a food matrix.
30. The food product according to any one of clauses 27 to 29, wherein the food product is a:
   (a) chocolate, such as but not limited to, milk chocolate, bittersweet chocolate, dark chocolate, white chocolate, or flavoured chocolate: or,
   (b) a confectionary composition, such as but not limited to, a chocolate flavoured composition: or,
   (c) a chocolate filing, such as but not limited to, a chocolate filing placed within a chocolate shell or inside a baked product wherein the baked product can be, but is not limited to, a cookie, pastry, bread or a cake: or,
   (d) a cream filling, such as but not limited to, a cream filling inside a baked product wherein the baked product can be, but is not limited to, a cookie, pastry, bread or a cake.

### DETAILED DESCRIPTION

Embodiments of the present disclosure will be described more fully hereinafter in the following text. Embodiments of the claims may, however, be embodied in many different forms and should not be construed as limited to the embodiments set forth herein.

The words “comprising.” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred systems and methods are now described.

Some of the terms used to describe the present invention are set out below:

“Agglomerated” refers to particles that are gathered, clustered or growing together. Agglomeration is commonly referred to as particles size enlargement. While powder agglomeration results in particles that look visibly different, chemically speaking the solid particles are the same as before agglomeration. The only difference is that agglomerated particles are held together by binding mechanisms that leaves voids between the particles. These voids leads to a porous product, which could make the agglomerated materials more soluble and permeable than loose powders.

“Brunauer-Emmett-Teller” (BET) refers to the multi-point measurement of a specific surface area of a substance through gas adsorption analysis, where an inert gas (for example nitrogen) is continuously flowed over a solid sample, or the solid sample is suspended in a defined gaseous volume.

“Hunter Lab colorimetric parameters” refers to a color scale based on the Opponent-Color Theory. This theory assumes that the receptors in the human eye perceive color as the following pairs of opposites. Hunter Lab color parameters are described as (L, a, b) coordinates, wherein L is a scale of light versus dark where a low number (0-50) indicates dark and a high number (51-100) indicates light: a is a scale of red versus green where a positive number indicates red and a negative number indicates green; and, b is a scale of yellow versus blue where a positive number indicates yellow and a negative number indicates blue. All three values are required to completely describe an object's color.

“CIELAB color space” (also known as CIE L*A*B*) refers to a 3D color model representing all colors visible to the average human eye. The CIELAB color space is based on three axes. L* for the lightness from black (0)) to white (100), a* from green (−128) to red (+128), b* from blue (−128) to yellow (+128). These three color parameters define the real color of an object or sample. If one needs to compare the color of a sample to a standard (or reference material), color differences are calculated as A values (sample value-standard value=color difference). If ΔL* is positive, the sample is lighter than the standard. If ΔL* is negative, it is darker than the standard. If Δa* is positive, the sample is redder (or less green) than the standard. If Δa* negative, it is greener (or less red) than the standard. If Δb* is positive, the sample is more yellow (or less blue) than the standard. If Δb* is negative, it is bluer (or less yellow) than the standard. The total color difference is determined by the ΔE00 value. The ΔE00 value is a calculated value which accounts for the differences between the L*, a* and b* values of the sample and the standard. The human eye can detect a color difference as from a ΔE00 value of 1.

“D10” refers to a particle size distribution parameter which signifies a size in the size distribution at which 10% of the total particles are smaller than this size.

“D50” refers to a particle size distribution parameter which signifies a size in the size distribution at which 50% of the total particles are smaller than this size and 50% of the total particles are larger than this size.

“D90” refers to a particle size distribution parameter which signifies a size in the size distribution at which 90% of the total particles are smaller than this size.

“Degree of polymerization” (DP) refers to the number of monomeric units in an oligomer. For example, DP1 contains one monomeric unit and an example includes, but is not limited to, fructose or glucose. For a further example, DP2 contains two monomeric unit and an example includes, but is not limited to, maltose (which is a glucose polymer of two glucose units). The percentage of DP1 and/or DP2 is expressed on a dry substance basis: it is assumed that the composition does not contain any moisture.

“Dextrin” refers to low-molecular-weight carbohydrates produced by the hydrolysis of starch or glycogen. The low-molecular-weight carbohydrates are generally mixtures of polymers of D-glucose units linked by α-1,4 or α-1,6 glycosidic bonds. Examples of the methods in which dextrins can be produced from starch include, but are not limited to, (a) enzyme digestion using enzymes such as amylases: or, (b) the application of heat under acidic conditions. Examples of dextrins include, but are not limited to, pyrodextrins, oligomers of dextrins, maltodextrins and cyclodextrins.

“Dextrose equivalent” (DE) refers to the measure of the amount of reducing sugars present in a sugar product, expressed as a percentage on a dry basis relative to dextrose.

“Disaccharides” refers to any substance that is composed of two molecules of simple sugars (i.e., monosaccharides) linked to each other. Examples of disaccharides include, but are not limited to, sucrose, lactose and maltose.

“Essentially water” refers to water wherein trace amounts of other compounds may be present. In some examples, the term “essentially water” is water.

“Fibersol-2 NONGMO” refers to an example resistant dextrin sold by Archer Daniels Midland Company. The fiber used was Fibersol-2 NONGMO (resistant maltodextrin) 013301, ADM.

“Food matrix” refers to a physical domain that contains and/or interacts with specific constituents of food (for example a nutrient), providing functionalities and behaviors which are different to those exhibited by the constituents in isolation or a free state.

“The flowability index (FFC)” refers to the flowability of a powder. The FFC is calculated with the following equation: FCC=σ₁/σ_{c}, wherein σ₁ is the major consolidation stress and σ_{c} is the unconfined yield strength. This ratio is an index of the flow properties and can be used to classify flowability. When calculating the FFC, variable pressures are used to make a curve which is called the flow function (σc=f(σ1)). From the flow function, the flowability index of a powder can be calculated.

“Frutafit® HD” refers to an example inulin produced by Sensus. An inulin is a type of dietary, soluble fiber that is found in plants.

“Glass transition temperature” (Tg) refers to the temperature at which a material undergoes a phase change from a hard and relatively brittle “glassy” state to viscous or “rubbery.” phase as the temperature is increased. The temperature at which a material undergoes the phase change is dependent on factors including, but not limited to, molecular structure, molecular weight, moisture content and the amount of low molecular weight materials that can act as plasticizers.

“Microdevice” refers to miniaturized reaction vessels fabricated, at least partially, by methods of micro technology and precision engineering. The dimensions of the internal structure of the microdevice's fluid channels can vary substantially, but typically range from the sub-micrometer to the sub-millimeter range. Microdevices most often, but not necessarily, are designed with microchannel architecture, and are usually fabricated by methods including, but not limited to, micro technology, precision engineering and 3D printing. These structures contain many channels and each microchannel is used to convert a small amount of material. Free microstructure shapes, not forming dedicated channels, are also possible. Free microstructure shapes can be made by using 3D printing. Several materials such as silicon, quartz, glass, metals and polymers can be used to construct microdevices.

“Micro mixer” refers to a static or kinetic micro mixer, a diffusion micro mixer, a cyclone-type micro mixer, a multi-lamination micro mixer, a focus micro mixer, or a split-and-recombined micro mixer. Examples of micro mixers are described in PCT/EP2011/000193.

“Moisture” refers to the water or another liquid which is diffused in a small quantity as vapor within a solid. The small quantity of vapour can be quantified as less than 13 weight %, or, less than 10 weight %, or, less than 7.5 weight %, or, less than 6 weight %.

“Monosaccharides” refers to simple sugars that are made up of from three to seven carbons in either a linear chain or ring-shaped molecules. Examples of monosaccharides include, but are not limited to, glucose, galactose and fructose.

“Near white” refers to a color that can be expressed using Hunter Lab colorimetric parameters. Near white has the Hunter Lab colorimetric parameters of from 96 to below: 100 (L), from −1.5 to +1.5 (a) and from 0 to +4 (b).

“Non-agglomerated” refers to particles that are not gathered, clustered or growing together.

“Nutriose FM10” refers to an example resistant dextrin sold by Roquette®.

“Nutriose FM6” refers to an example resistant dextrin sold by Roquette®.

“Oil binding capacity” (OBC) refers to a measurement of the amount of oil that a substance or a product can retain (bind) per gram of sample. Having a resistant dextrin with an optimum OBC is important for food or beverage products because the OBC affects the rheology and hardness thereof: Too high an OBC value can lead to an undesirable hard texture, whilst too low an OBC value can lead to oil oozing out of the product. In particular, this phenomenon relates to confectionary products containing fat.

“Particulate form” refers to a combination of one or more particles having a D10 in the range of from 1 to 100 μm, D50 in the range of from 1 to 150 μm and a D90 in the range of from 1 to 300 μm. The particulate form can be homogeneous throughout. Alternatively, the particulate form is not necessarily homogeneous throughout.

“Promitor SGF 70 R” refers to an example resistant dextrin sold by Tate&Lyle. The resistant dextrin comprises at least 70 weight % resistant dextrin on a dry solid basis. The fiber is sourced from a soluble corn fiber.

“Promitor NGR 85” and “Promitor SGF 70 L” refers to an example resistant dextrin sold by Tate&Lyle. The resistant dextrin comprises at least 85 weight % resistant dextrin on a dry solid basis. The fiber is sourced from a soluble corn fiber. Promitor SGF 70 R is the resistant dextrin in powder form and Promitor SGF 70 L is the resistant dextrin in liquid form.

“Resistant dextrin” refers to dextrins that are resistant or partially resistant to the digestive enzymes present in the small intestine. Resistant dextrins contain α-1,2 and α-1,3 glycosidic bonds in addition to the α-1,4 and α-1,6 glycosidic bonds, which for example are also present in starch. The resistant dextrin also contains reducing terminuses of the resistant dextrin which may contain β-1,6 glycosidic bonds. The α-1,3, α-1,2 and α-1,6 glycosidic bonds cannot be decomposed by various digestive enzymes in the human body, contributing to enzyme resistance. The resistant dextrin may be in particulate form or liquid form.

“SPAN” refers to a value used to define the particle size distribution of a substance. SPAN is calculated from D90, D10 and D50 using the formula: (D90-D10)/D50. SPAN provides an indication of how far the 10 percent and 90 percent points are apart, normalized with the midpoint.

“Weight %” refers to the percentage weight in grams of a component of a composition for every 100 grams of a composition. For example, if a resistant dextrin contained DP1 at 10 weight %, then there is 10 g of DP1 for every 100 g of resistant dextrin.

“Weight-average molecular weight” refers to the weight fraction of molecules in a polymer sample and provides the average of the molecular masses of the individual macromolecules in the polymer sample. The weight-average molecular weight can be calculated with the following equation: M_{W}=ΣNᵢMᵢ²IΣNᵢMᵢ where M_{w} is the weight-average molecular weight and Nᵢ is the number of molecules of molecular mass Mi.

“Wettability” refers to the time (typically in seconds) necessary for a given amount of powder to penetrate the still surface of water at a specific temperature and without any agitation. In other words, wettability is the ability of a powder to absorb water on its surface and get wet.

“White” refers to a color that can be expressed using Hunter Lab colorimetric parameters. White has the parameters: 100 (L), 0 (a), 0 (b).

### Resistant Dextrin (in Particulate Form)

Resistant dextrin in powder (particulate) form has various desirable properties, described herein, which provide an improved resistant dextrin for use in food and/or beverage products.

In some examples, the resistant dextrin has a SPAN of at most 2.7. Alternatively, the resistant dextrin has a SPAN of at most 2.15, or, at most 2, or, at most 1.8, or, at most 1.6, or, at most 1.4.

In some examples, the resistant dextrin has a specific surface area of from 0.05 to 0.20 m²g as measured by the Brunauer-Emmett-Teller (BET) absorption method. Alternatively, the resistant dextrin has a specific surface area of from 0.75 to 1.19 m²g, or, from 0.1 to 0.18 m²g, or, from 0.12 to 0.18 m²g as measured by the Brunauer-Emmett-Teller (BET) absorption method.

In some examples, the resistant dextrin has an OBC of from 0.60 to 1.35 g/g. Alternatively, the resistant dextrin has an OBC of from 0.70 to 1.33 g/g, or, from 0.8 to 1.25 g/g, or, from 0.9 to 1.20 g/g, or, from 1.0 to 1.15 g/g.

In some examples, the resistant dextrin has a wettability such that 10 g of the resistant dextrin in particulate form fully submerges in 250 ml of water at 25° C. within at most 20 seconds. Alternatively, the resistant dextrin has a wettability such that 10 g of the resistant dextrin in particulate form fully submerges in 250 ml of water at 25° C. within at most 17.5 seconds, or, at most 15 seconds, or, at most 12.5 seconds, or, at most 10 seconds, or, at most 7.5 seconds, or, at most 5 seconds.

In some examples, the resistant dextrin is white or near white in color. Alternatively, the resistant dextrin has Hunter Lab colorimetric parameters of from 95 to 100 (L): from −1.5 to +1.5 (a); and, from 0 to +5 (b). Alternatively, the resistant dextrin has Hunter Lab colorimetric parameters of from 96 to 100 (L): from −1.4 to +1.4 (a); and from, 0 to +4 (b). Optionally, the Hunter Lab colorimetric parameters are measured on a Chroma-meter CR410.

In some examples, the resistant dextrin has a D10 in the range of from 1 to 40 μm, or, from 5 to 30 μm, or, from 10 to 20 μm, or, from 13 to 19 μm. Alternatively, the resistant dextrin has a D10 in the range of no more than 40 μm, or, no more than 35 μm, or, no more than 30 μm. Alternatively, the resistant dextrin has a D10 in the range of from 15 to 35 μm, or, from 2 to 26 μm, or, from 3 to 24 μm, or, from 6 to 14 μm, or, from 20 to 40 μm, or, from 1 to 20 μm, or, from 1 to 15 μm, or, from 1 to 10 μm, or, from 1 to 5 μm, or, from 3 to 40 μm, or, from 3 to 35 μm, or, from 3 to 30 μm, or, from 3 to 15 μm, or, from 3 to 10 μm, or, from 5 to 40 μm, or, from 5 to 35 μm, or, from 5 to 30 μm, or, from 5 to 25 μm, or, from 5 to 15 μm, or, from 5 to 10 μm, or, from 10 to 40 μm, or, from 10 to 35 μm, or, from 10 to 30 μm, or, from 10 to 25 μm, or, from 10 to 20 μm, or, from 15 to 40 μm, or, from 15 to 35 μm, or, from 15 to 30 μm, or, from 15 to 25 μm, or, from 15 to 20 μm, 20 to 40 μm, or, from 20 to 35 μm, or, from 20 to 30 μm, or, from 20 to 25 μm.

In some examples, the resistant dextrin has a D50 in the range of from 5 to 100 μm, or, from 10 to 80 μm, or, from 20 to 60 μm, or, from 30 to 50 μm, or, from 35 to 45 μm. Alternatively, the resistant dextrin has a D50 in the range of from 5 to 100 μm, or, from 5 to 95 μm, or, from 60 to 95 μm. Alternatively, the resistant dextrin has a D50 in the range of from 5 to 110 μm, or, from 5 to 95 μm, or, from 5 to 90 μm, or from 5 to 75 μm, or, from 5 to 60 μm, or, from 5 to 45 μm, or, from 5 to 30 μm, or, from 5 to 25 μm, or from 5 to 15 μm, or, from 8 to 60 μm, or, from 8 to 45 μm, or, from 8 to 30 μm, or, from 8 to 25 μm, or, from 8 to 20 μm, or, from 8 to 15 μm, or, from 10 to 100 μm, or, from 10 to 85 μm, or, from 10 to 95 μm, or, from 10 to 90 μm, or, from 10 to 75 μm, or, from 10 to 60 μm, or, from 10 to 45 μm, or, from 10 to 30 μm, or, from 10 to 25 μm, or, from 10 to 20 μm, or, from 10 to 15 μm, or, from 20 to 100 μm, or, from 20 to 95 μm, or, from 20 to 90 μm, or, from 20 to 75 μm, or, from 20 to 60 μm, or, from 20 to 45 μm, or, from 20 to 30 μm, or, from 20 to 25 μm, or, from 25 to 100 μm, or, from 25 to 75 μm, or, from 25 to 50 μm, or, from 50 to 100 μm, or, from 50 to 75 μm, or, from 50 to 100 μm, or, from 50 to 75 μm, or, from 75 to 100 μm.

In some examples, the resistant dextrin has a D90 in the range of from 20 to 200 μm, or, from 30 to 150 μm, or, from 40 to 125 μm, or, from 50 to 100 μm, or, from 60 to 90 μm, or, from 70 to 85 μm, or, from 75 to 80 μm. Alternatively, the resistant dextrin has a D90 in the range of from 20 to 175 μm, or, from 20 to 160 μm, or, from 20 to 100 μm. Alternatively, the resistant dextrin has a D90 in the range of from 20 to 200 μm, or, from 20 to 180 μm, or, from 10 to 160 μm, or, from 20 to 140 μm, or, from 20 to 100 μm, or, from 20 to 80 μm, or, from 20 to 60 μm, or, from 20 to 40 μm, or, from 40 to 200 μm, or, from 40 to 180 μm, or, from 40 to 160 μm, or, from 40 to 140 μm, or, from 40 to 120 μm, or, from 40 to 100 μm, or, from 40 to 80 μm, or, from 40 to 60 μm, or, from 60 to 200 μm, or, from 60 to 180 μm, or, from 60 to 160 μm, or, from 60 to 140 μm, or, from 60 to 120 μm, or, from 60 to 100 μm, or, from 60 to 80 μm, or, from 80 to 200 μm, or, from 100 to 200 μm, or, from 150 to 200 μm, or, from 80 to 150 μm, or, from 100 to 150 μm.

In some examples, the resistant dextrin comprises DP1 and DP2, wherein DP1 and DP2 are present at a combined weight % of at most 40 weight %, or, at most 30 weight %, or, at most 20 weight %.

In some examples, the resistant dextrin comprises monosaccharides and disaccharides. The monosaccharides and disaccharides present are predominantly, but not limited to, glucose and glucose disaccharides such as maltose and isomaltose. Other monosaccharides and disaccharides may be present. Preferably, the resistant dextrin has a total amount of monosaccharides and disaccharides of at most 25 weight %, or, at most 20 weight %, or, at most 15 weight %, or, at most 12.5 weight %, or, at most 10 weight %, or, at most 5 weight 5%, or, at most 2 weight %, or, at most 1 weight %, or, at most 0.5 weight % on a dry solids basis.

In some examples, the resistant dextrin is free of 5-hydroxymethylfurfural (HMF). HMF is a compound which is undesirably formed during the manufacturing process of the dextrin. By being HMF free, it is herein understood that the resistant dextrin has a total amount of HMF of at most 5 ppm, or, at most 2.5 ppm, or, at most 1 ppm.

In some examples, the resistant dextrin has a degree of polymerization (DE) of from 5 to 20, or, from 7.5 to 18, or, from 5 to 17, or, from 7.5 to 16, or, from 10 to 15, or, 12 weight % on a dry solid basis.

In some examples, the resistant dextrin has a weight-average molecular weight of from 1000 to 2000 g/mol, or, from 1250 to 1750 g/mol. The viscosity of the resistant dextrin is dependent on the weight-average molecular weight. In particular scenarios, a specific viscosity is required in the end product and therefore a low weight-average molecular weight is advantageous to reduce the impact of the resistant dextrin on the product's viscosity.

In some examples, the resistant dextrin has a viscosity of from 400 to 800 mPa·s, or, from 500 to 700 mPa·s, or, from 550 to 650 mPa·s, or, from 580 to 630 mPa·s, or, at 614 mPa·s at a temperature of 25° C. when 66.7 weight % of the resistant powder is dissolved in water.

In some examples, the resistant dextrin has a Tg of less than 80° C. at a moisture content of 5 weight % or more, or, the resistant dextrin has a Tg of less than 40° C. at a moisture content of 8 weight % or more, or, the resistant dextrin has a Tg of less than 20° C. at a moisture content of 12 weight % or more.

In some examples, the resistant dextrin has a flowability index (FFC) of from 6 to 10, or, from 6.5 to 10, or, from 7 to 9, or, from 7.5 to 8.5, or, 7.9 to 8.1, or, 7.97.

In some examples, the resistant dextrin has a moisture content of at most 13 weight % moisture, or, at most 10 weight % moisture, or, at most 7.5 weight % moisture, or, at most 6 weight % moisture.

### Resistant Dextrin (in Liquid Form)

Another aspect of the present invention relates to a resistant dextrin in liquid form.

In some examples, the resistant dextrin in liquid form comprises a resistant dextrin and water.

Preferably, the resistant dextrin in liquid form comprises the resistant dextrin at from 60 to 75 weight %, or, from 65 to 75 weight %, or, from 67.5 to 72.5 weight %, or, from 70 to 72 weight %, or, at 71 weight %: the balance at each weight % being essentially water.

Advantageously, after drying, the resistant dextrin in liquid form is a resistant dextrin as set out above (following the “Resistant dextrin (in particulate form)” sub-heading).

### Method of Producing the Resistant Dextrin (in Particulate Form)

Another aspect of the present invention relates to a method of making the resistant dextrin (in particulate form). The method of making the resistant dextrin (in particulate form) comprises the steps:
(a) providing a saccharide feed comprising at least 35 weight %, or, at least 45 weight %, or, at least 55 weight % on a dry solid basis of dextrose and/or dextrose oligomers;
(b) heating the saccharide feed to a temperature of at least 60° C.;
(c) adding an acidifying catalyst to form an acidic composition;
(d) heating the acidic composition up to at least 120° C., or, at least 140° C., or, at least 180° C., or, at least 190° C.;
(e) injecting the acidic composition through a first microdevice to react the dextrose and/or dextrose oligomers with the acid catalyst in the presence of water for a time sufficient to produce a first reacted composition wherein at least 60 weight %, or, at least 70 weight %, or, at least 80 weight %, or, at least 85 weight % of the dextrose and/or dextrose oligomers have reacted, and wherein the first reacted composition comprises from 60 to 90 weight %, or, from 70 to 80 weight %, or, 75% weight dry solids;
(f) extracting the water from the first intermediate product (first reacted composition) to obtain a water-depleted composition comprising at least 90 weight %, or, 95 weight %, or, 98 weight % dry solids;
(g) injecting the water-depleted composition through a second microdevice to react any non-reacted dextrose and/or dextrose oligomers with the acid catalyst at a temperature of at least 160° C., or, 180° C., or, 200° C., or, at least 210° C., or, at least 220° C. for a time sufficient to produce a second reacted composition wherein at least 90 weight %, or, at least 92 weight % of the dextrose and/or dextrose oligomer have reacted, and wherein the second reacted composition comprises from 60 to 80 weight %, or, from 65 to 75 weight %, or, 70 weight % dry solids;
(h) refining the second reacted composition to form a refined second reacted composition;
(i) drying the refined second reacted composition to produce the resistant dextrin.

During step (b), a heat ramp operating at from 40 to 60° C., or, from 45 to 55° C., or, 50° C. is preferably used. Preferably, the heat ramp operates at a heating rate of 100° C. per second.

During step (e), the time sufficient to produce a first reacted composition is from 1 to 30 seconds, or, from 5 to 20 seconds, or, from 7.5 to 15 seconds, or, 10 seconds.

During step (f), the water is preferably extracted from the first reacted composition (also referred to herein as a first intermediate product) with a flash tank. Preferably, the flash tank is held at atmospheric pressure to allow the expansion of the reacted material, and thus allow any water present to be removed in the form of steam.

During step (g) the time sufficient to produce a second reacted composition is from 1 to 30 seconds, or, from 5 to 20 seconds, or, from 7.5 to 15 seconds, or, 10 seconds.

During step (h), the second reacted composition can be refined by being decolorized. To decolorize the resistant dextrin, the second reacted composition is combined with a caustic agent and an oxidant to form a mixture. Preferably, the caustic agent is sodium hydroxide, potassium hydroxide, calcium hydroxide and/or combinations thereof. Preferably, the caustic agent is present at a weight % that maintains the pH of the mixture at from 5 to 10 pH, or, at from 5.5 to 8 pH, or, at from 6 to 6.5 pH. Preferably, the oxidant is hydrogen peroxide although other oxidants such as hypochlorites, permanganates and the like can also be utilized. Preferably, the oxidant is present at from 1 to 10 weight %. The mixture is maintained at a temperature of at least 55° C., or, at least 65° C., or, at least 75° C., or, at least 85° C., or, at least 95° C. for a time sufficient to decolorize the second reacted composition. Preferably, the time sufficient to decolorize the second reacted composition is at least 60 minutes, or, at least 90 minutes, or, at least 120 minutes, or, at least 300 minutes, or, a time sufficient to achieve the desired color. Preferably, the water content of the decolorized second reacted composition is adjusted until the water content is at least 10 weight %, or, at least 20 weight %, or, at least 25 weight %, or, at least 30 weight %.

During step (h), the second reacted composition can be further refined by being contacted with active carbon. The second reacted composition is contacted with a powder containing active carbon, preferably the powder is a coarse powder, e.g. a powder having a D50 of at least 500 μm, or, at least 1000 μm. Preferably, the second reacted composition is contacted with a powder containing active carbon at a temperature of at most 100° C., or, at most 90° C., or, at most 80° C., or, at most 70° C. Preferably, the second reacted composition is contacted with a powder containing active carbon for a time of at least 10 minutes, or, at least 60) minutes, or, at least 120 minutes. More preferably, the second reacted composition is contacted with a powder containing active carbon for a time of from 10 minutes to 240 minutes, or, from 60 minutes to 180 minutes, or, from 60 to 120 minutes.

During step (h), the second reacted composition is preferably subjected to a neutralization reaction to neutralize any residual oxidation agent left over from the decolorization. Preferably, the neutralization is performed with sodium bisulfite. Preferably, the oxidation agent is neutralized to a level of at most 5 ppm, or, at most 2.5 ppm, or, at most 1 ppm, or, at most 0.5 ppm. The second reacted composition can then be filtered to remove the active carbon.

During step (h), the second reacted composition can be further refined by cooling and then being subjected to electrodialysis. The second reacted composition is cooled to a temperature of at most 50° C., or, at most 45° C. The cooled, second reacted composition can be subjected to an electrodialysis reaction. Preferably, the electrodialysis reaction removes at least 50 weight %, or, at least 60 weight %, or, at least 70 weight %, or, at least 80 weight % of salts.

During step (h), the second reacted composition can be further refined by being subjected to an ion exchange process. Preferably, the second reacted composition undergoes the ion exchange process until the second reacted composition has a salt level of at most 10 weight %, or, at most 5 weight %, or, at most 2.5 weight %, or, at most 1 weight %.

During step (h), the second reacted composition can be further refined by being contacted with active carbon. The second reacted composition can be contacted with a powder containing active carbon. Preferably, the powder is a coarse powder. Preferably, the second reacted composition is contacted with the powder at a temperature of at least 20° C., or, at least 25° C., or, at least 30° C. Preferably, the second reacted composition is contacted with the powder for a time sufficient to remove any HMF present to a level of at most 5 ppm, or, at most 2.5 ppm, or, at most 1 ppm. The second reacted composition is then filtered to remove the active carbon. Preferably, the filter used is a sterile filter. Advantageously, the method of making resistant dextrins results in a reduction in the formation of degradation products such as furans, furfural and 5-hydroxymethyl furfural (5HMF) in the resultant product.

During step (h), the second reacted composition can be further refined by being subjected to water-evaporation. Preferably, the water-evaporation is conducted on a thin-film evaporator, falling film evaporator or plate evaporator. Preferably, water is evaporated until the second reacted composition has a dry solids content of at least 50 weight %, or, at least 60 weight %, or, at least 70 weight %, or, at least 72 weight % is achieved. The second reacted composition is then diluted with water until a dry solids content of at least 20 weight %, or, at least 40 weight %, or, at least 50 weight %, or, at least 55 weight % is achieved.

During step (h), the second reacted composition can be further refined by being pasteurized. Preferably, pasteurization occurs at a temperature of at least 70° C., or, at least 80° C., or, at least 90° C., or, at least 95° C.

During step (i), the (refined) second reacted composition is preferably dried by using spray drying. Another method of drying includes, but is not limited to, belt drying. Examples of devices that can be used to spray dry the (refined) second reacted composition include, but are not limited to, dual fluid nozzle spray dryer, single fluid nozzle spray dryer, rotary atomizer spray dryer, high-pressure nozzle spray dryer, and/or steam-assisted atomization spray dryer, small scale spray drying devices such as Buchi (Buchi, CH) spray dryer and a pilot scale spray dryer such as Niro MOBILE MINOR™. Anhydro PSD55 spray dryer equipped with rotary atomizer, Model MM-IN spray dryer and large scale drying devices such as co-current with integrated belt and nozzle atomizer (such as Filtermat™), co-current conical base with rotary atomizer (such as a single stage spray dryer), co-current with nozzle atomizer (such as Toll FORM DRYER), mixed flow spray dryer with integrated fluid bed and rotary or nozzle atomizer (such as fluidized Spray Dryer FSD™), mixed flow spray dryer with integrated filter and fluid bed and rotary or nozzle atomizers (such as integrated Filter Dryer IFD™).

During step (i), the step of drying the refined second reacted composition is performed for a sufficient amount of time until the resistant dextrin has from 10 to 100 weight %, or, from 25 to 98 weight %, or, from 50 to 96 weight %, or, from 75 to 94 weight %, or, at 90 weight % dry solids. Alternatively, the step of drying the refined second reacted composition is performed for a sufficient amount of time until the resistant dextrin has at most 13 weight % moisture, or, at most 10 weight % moisture, or, at most 7.5 weight % moisture, or, at most 6 weight % moisture.

During step (i), the refined second reacted composition can be dried by using spray drying, during which the temperature is controlled: the temperature at which the spray drying is performed can control the moisture content of the resultant product because a higher temperature will allow a drier product to be obtained. The temperature at which the spray drying is conducted is from 60 to 130° C., or, from 60 to 120° C., or, from 65 to 100° C., or, from 75 to 110° C. or, from 75 to 115° C., or, from 80 to 120° C., or, from 85 to 130° C. Alternatively, the temperature at which the spray drying is conducted is from 125 to 250° C., or, from 125 to 185° C. or, from 125 to 160° C., or, from 130 to 150° C., or, from 150 to 250° C., or, from 150 to 225° C., or, from 150 to 200° C., or, from 175 to 250° C., or, from 175 to 225° C., or, from 200 to 250° C.)

During step (i), the (refined) second reacted composition can be dried using spray drying. When drying the refined second reacted composition with a spray dryer, spray drying conditions such as outlet temperature, the concentration of solids in the (refined) second reacted composition, the particle size desired in the resultant product, the period of time in which the (refined) second reacted composition is exposed to the spray drying device and if it would be beneficial to dry the particles during flight are considered. A high outlet temperature is beneficial if quick drying of the (refined) second reacted composition is desired. To control the outlet temperature, parameters such as, but not limited to, inlet air temperature, feed solids, air flow; feed temperature and flow rate are varied. With regard to concentration, a 50 to 55 weight %, or, 50 to 52 weight % dry solid concentration is required to ensure that water can be evaporated at a reasonable temperature and residence time. Alternatively, a 50 to 87 weight %, or 60 to 80 weight %, or, 65 to 75 weight %, or 67 to 73 weight %, or, 70 to 72 weight %, or 71 weight % of dry solid concentration is required to ensure that water can be evaporated at a reasonable temperature and residence time if the spray dryer is able to pulverize the liquid material. This solid concentration content depends on the spray system capability of the spray dryer. The spray system should avoid forming cotton candy structures by forming elongated droplets (filaments). Such cotton candy structures have poor flowability, and consequently it is difficult for these filaments to flow out of the drying chamber. The solid concentration and the feed temperature are the best parameters to ensure good pulverization of the feed. Increasing the feed temperature and decreasing the solid concentration enable the decrease of the feed viscosity and make the pulverization easier. If the (refined) second reacted composition contains too much water then the (refined) second reacted composition may not dry quickly enough, and may become sticky and agglomerate with other particles or stick to equipment surfaces. Furthermore, regarding concentration, a low solid concentration (for example a concentration of 30 to 40 weight % dry solids) can lead to smaller particle sizes (for example particles with a D50 of from 40 μm or below) in the resultant product. Another way to control the particle size of the resultant product is to select the nozzle size used on the spray dryer: the nozzle can influence the size of droplets formed, and therefore influence the size of the particles finally formed. Drying the particles during flight is beneficial if the particles are likely to agglomerate with other particles upon settling on a surface.

During step (i), the (refined) second reacted composition can be dried by using spray drying, during which the spray dryer can be fitted with a nozzle, such as a high-pressure nozzle. The nozzle aids the atomization of the (refined) second reacted composition. Alternatively, other techniques can be used to achieve atomization of the (refined) second reacted composition such as, but not limited to, steam-assisted atomization. To atomize the (refined) second reacted composition with steam-assisted atomization, the (refined) second reacted composition is mixed with steam in a nozzle which results in the production of very finely atomized droplets. Advantageously, the very finely atomized droplets provide particles with the size and narrow particle size distribution required in the resultant resistant dextrin product. Further advantageously, steam-assisted atomization produces particles which are spherical, or almost spherical, because the particles do not collide so frequently during formation and do not dry during droplet formation. Methods of using and examples of atomization devices are further described in WO2005/079595, WO03/090893 and WO01/45858.

The conditions under which spray drying can be conducted in a single stage dryer with a rotary disc system are set out below in Table 1, and the conditions under which spray drying can be conducted in a single stage dryer with a high pressure nozzle spraying system and an external fluidized bed are set out below in Table 2.

TABLE 1
Possible conditions to conduct spray drying, when using
a single stage dryer with a rotary disc system.

| | | | |
|---|---|---|---|
| Water evaporation capacity of the spray tower when pure | 100 | 100 | 100 |
| water is sprayed | | | |
| (Refined) Second reacted composition temperature (° C.) | 80 | 80 | 80 |
| (Refined) Second reacted composition dry substance (% | 50 | 50 | 50 |
| wt) | | | |
| (Refined) Second reacted composition flow (kg/h) | 120 | 120 | 120 |
| Inlet air temperature (° C.) | 152 | 147 | 155 |
| Outlet air temperature (° C.) | 86 | 84 | 88 |
| Air flow (m³/h) | 950 | 950 | 950 |
| Rotary disc speed (rpm) | 20000 | 20000 | 20000 |
| Humidity in the drying chamber (g/kg of air ) | 8.8 | 8.9 | 7.4 |
| Pressure at the exit of the cyclone (m bars) | 10 | 10 | 10 |
| Moisture content of the dried second reacted composition | 4.9 | 4.8 | 5.0 |
| (the resistant dextrin) (%) | | | |
| D10 of the dried second reacted composition (the resistant | 15.1 | 17.3 | 15.2 |
| dextrin) (μm) | | | |
| D50 of the dried second reacted composition (the resistant | 39.5 | 44.7 | 40.8 |
| dextrin) (μm) | | | |
| D90 of the dried second reacted composition (the resistant | 86.5 | 90.9 | 90.9 |
| dextrin) (μm) | | | |
| Span of the dried second reacted composition (the resistant | 1.809 | 1.648 | 1.857 |
| dextrin) | | | |

TABLE 2
Possible conditions to conduct spray drying, when using a single stage dryer
with a high pressure nozzle spraying system and an external fluidized bed.

| | | | |
|---|---|---|---|
| Water evaporation capacity of the | 100 | 100 | 100 |
| spray tower when pure water is | | | |
| sprayed (kg/h) | | | |
| (Refined) Second reacted | 60.5 | 63.7 | 62.9 |
| composition temperature (° C.) | | | |
| (Refined) Second reacted | 79.8 | 79.8 | 79.5 |
| composition pasteurization | | | |
| temperature (° C.) | | | |
| (Refined) Second reacted | 51 | 51 | 51 |
| composition dry substance (% wt) | | | |
| (Refined) Second reacted | 123 | 113 | 112.5 |
| composition flow (kg/h) | | | |
| Inlet air temperature (° C.) | 150.1 | 150.0 | 150.2 |
| Inlet air relative humidity (%) | 50.9 | 50.7 | 47.9 |
| Outlet air temperature (° C.) | 83.2 | 82.8 | 82.4 |
| Main air flow going to the drying | 3612 | 3246 | 3325 |
| chamber (m³/h) | | | |
| Nozzle pressure (bars) | 162 | 194 | 196 |
| Nozzle | SK Spray Dry | SK Spray Dry | SK Spray Dry |
| | Nozzles from | Nozzles from | Nozzles from |
| | Spraying | Spraying | Spraying |
| | systems Co. ® | systems Co. ® | systems Co. ® |
| | Orifice Dia. | Orifice Dia. | Orifice Dia. |
| | (mm) = .043 | (mm) = .038 | (mm) = .038 |
| | (1.09) / Size | (.96) / Size | (.96) / Size |
| | NO. 57; Core | NO. 62; Core | NO. 62; Core |
| | size NO 20; | size NO 20; | size NO 20; |
| | Spray angle | Spray angle | Spray angle |
| | (°) 89 | (°) 85 | (°) 85 |
| Pressure in the drying chamber (m | −0.98 | −1.03 | −0.99 |
| bars) | | | |
| Air flow going to the first section of | 67.0 | 63.0 | 67.0 |
| the fluidized bed (m³/h) | | | |
| Temperature of the air going to the | 29.0 | 29.3 | 28.8 |
| first section of the fluidized bed (° C.) | | | |
| Air flow going to the second section | 67.0 | 74.4 | 78.0 |
| of the fluidized bed (m³/h) | | | |
| Temperature of the air going to the | 28.6 | 28.5 | 28.0 |
| second section of the fluidized bed | | | |
| (° C.) | | | |
| Air flow going to the third section of | 77.0 | 79.0 | 76.0 |
| the fluidized bed (m³/h) | | | |
| Temperature of the air going to the | 25.5 | 25.3 | 24.0 |
| third section of the fluidized bed | | | |
| (° C.) | | | |
| Moisture content of the final powder | 5.5 | 5.1 | 4.9 |
| (the resistant dextrin) (%) | | | |
| D10 of the dried second reacted | 19.0 | 17.0 | 16.0 |
| composition (the resistant dextrin) | | | |
| (μm) | | | |
| D50 of the dried second reacted | 49.0 | 41.0 | 39.0 |
| composition (the resistant dextrin) | | | |
| (μm) | | | |
| D90 of the dried second reacted | 92.0 | 75.0 | 71.0 |
| composition (the resistant dextrin) | | | |
| (μm) | | | |
| Span of the dried second reacted | 1.5 | 1.4 | 1.4 |
| composition (the resistant dextrin) | | | |

Advantageously, spray drying produces the resistant dextrin in particulate form. Further advantageously, spray drying preserves the color of the resistant dextrin, thus reducing the degree of bleaching required to form a resistant dextrin that is white, or, near white in color.

In some examples, the dextrose and/or dextrose oligomers are provided in solid or liquid form, whereby the solid form is either a solidified form or a crystalline form. In some examples, the dextrose and/or dextrose oligomers can be obtained from corn or wheat starch that has undergone enzymatic hydrolysis refining. In some examples, the dextrose and/or dextrose oligomers preferably start in a solution containing 5 weight % dry solids of dextrose and/or dextrose oligomers, which is then concentrated to the desired dry solid content under vacuum.

A large range of acid catalysts could be used for catalyzing the polymerization to obtain the resistant dextrin. Preferably, these catalysts are acids which are allowable for consumption to reduce the otherwise necessary controls and costs to check for the presence of residual catalyst acid, and if necessary, remove the catalyst acids from the final product. Examples of the preferred acids to use are edible acids (food grade acids), hydrochloric acid, sulfuric acid, phosphoric acid, citric acid, malic acid, succinic acid, adipic acid, gluconic acid, tartaric acid, fumaric acid and/or combinations thereof. The amount of catalyst used is preferably below 15 weight % relative to the amount of dextrose and/or dextrose oligomers starting material used. Preferably the amount of catalyst is below this level, such as for example at most 12 weight %, or, at most 10 weight %, but not below 0.001 weight %.

In some examples, the microdevice is a micro mixer. The micro mixer is a static or kinetic micro mixer, a diffusion micro mixer, a cyclone-type micro mixer, a multi-lamination micro mixer, a focus micro mixer or a split-and-recombine micro mixer. A static micro mixer is any type of micro mixer in which the mixing of two or more fluids is performed by diffusion and optionally enhanced by transfer from laminar flow regime into transitional or turbulent flow regime such as described in EP0857080. A kinetic micromixer is a micro mixer in which specially designed inlays produce a mixing by artificially eddies, or in which the mixing of two or more fluids is enhanced by applying kinetic energy to the fluids (e.g. stirring, high pressure, pressure pulses, high flow velocity, nozzle release). A diffusion micro mixer is a mixer of the static type, in which the fluids are ducted in that way, that the distance between the single fluids is in the range of the diffusion coefficients at the process parameters. In most cases, diffusion micro mixers are taking advantage of multi-lamination of fluids such as described in EP1674152. EP1674150 and EP1187671. A cyclone-type micro mixer is a micro mixer based on the rotational mixing of two or more fluids, which are inserted in an asymptotic or non-asymptotic way into a mixing chamber, providing rotational speed of each fluid flow which is also disclosed in EP1674152. A multi-lamination micro mixer is a microstructure device where the single fluid streams are ducted very close to each other in lamination sheets or streams, to reduce the diffusion distance as it is disclosed in EP1674152. EP1674150, and EP1187671. A focus micro mixer is a kinetic mixer in which fluid streams are focused into a dense meeting point to be mixed by kinetic energy and turbulence. A split-and-recombine micro mixer is a micro mixer where single fluid streams are split up by mechanical or non-tactile forces (e.g. electrical fields, magnetic fields, gas flow), changed in direction and position and recombined by, at least, doubling the number of sub-streams to increase the diffusion area. The micro heat exchanger is a cross flow micro heat exchanger, counter-current flow micro heat exchanger, co-current flow micro heat exchanger or an electrically powered parallel flow micro heat exchanger and/or microdevices suitable for the reaction between dextrose and/or oligomers of dextrose and an acid catalyst. A cross flow micro heat exchanger is a miniaturized plate heat exchanger in which the single fluid streams are ducted in a crosswise matter as is disclosed in EP1046867. A counter-current flow micro heat exchanger is a miniaturized plate heat exchanger in which the single fluid streams are ducted in a way that the inlets as well as the outlets of both fluids are in opposite direction to each other and therefore the fluid streams are running against each other, which is also described in EP1046867. A co-current flow micro heat exchanger is a miniaturized plate heat exchanger in which the single fluid streams are ducted in a way that the inlets as well as the outlets of both fluids are at the same direction of the device to each other and, therefore, the fluid streams are running in parallel which is described in EP1046867. An electrically powered parallel flow micro heat exchanger is a miniaturized heat exchanger where the heating or cooling energy is given by electrical elements (resistor heater cartridges. Peltier-Elements) such as described in e.g. EP1046867. EP1402589. EP 1402589. A microdevice suitable for the reaction between dextrose and/or dextrose oligomers and acid catalysts is a micro channel device, possibly integrated with at least a membrane, porous sidewalls or micro separation nozzle elements. Alternative microdevices are provided by Kreido's micro reactor that possesses a moving part which in their case is the internal cylinder as is described in e.g. EP 1 866 066. A micro channel device integrated with a membrane is in the range of 1 to 2000 μm wide, 1 to 2000 μm deep and in direct contact with the membrane, which forms at least one side wall of the channel. The membrane can be a polymer, metal or ceramic membrane with pore sizes according to the process needs, ranging from some nanometer to the micrometer level. Porous sidewalls have pores of the same specifications than the membranes or micro separation nozzle elements suitable for the desired process, preferably in the range of some nanometer up to 1 mm diameter. The current invention relates to a process wherein the micro device is applied at sub-atmospheric pressure, atmospheric pressure or elevated pressure, in the range from very low pressures in the ultra-high vacuum range from 0 to 1000 bar.

Methods of using and examples of microdevices are further described in WO2011091962 and WO2011098240.

The use of microdevices to make resistant dextrins has numerous benefits. The benefits of microdevices compared to large scale processes include, but are not limited to, a large-scale batch process can be replaced by a continuous flow process, the smaller devices need less space, fewer materials and less energy are required, shorter responses times and an enhanced system performance. Consequently, microdevices significantly intensify heat transfer, mass transport and diffusional flux per unit volume or unit area.

Advantageously, through using microdevices the typical thickness of the fluid layer in the microdevices can be set to a few tens of micrometers (typically from 10 to 500 μm) in which diffusion plays a major role in the mass/heat transfer process. Due to a short diffusional distance, the time for a reactant molecule to diffuse through the interface to react with other molecular species is reduced to milliseconds and in some cases to nanoseconds. Therefore, the conversion rate is significantly enhanced, and the chemical reaction process is more efficient.

A large range of heating equipment can be used to apply heat during the steps of the method for making the resistant dextrin. Preferably, a heat ramp is used. Other methods to apply heat include, but are not limited to, hot air ovens, hot plates, heating mantles, muffle furnaces, hot oil baths and/or microwave digestion systems.

A large range of water extraction equipment can be used. Examples of water extraction equipment include, but are not limited to, flash tanks, wet-dry vacuums, extraction columns, centrifugal extraction equipment and/or mixer-settler extractors.

In some examples, the method of making the resistant dextrin further comprises the step of concentrating the saccharide feed to reach a concentration of at least 75 weight %, or, 80 weight %, or, 85 weight % dry solids basis of dextrose and/or dextrose oligomers. Preferably, the saccharide feed is concentrated by using a standard evaporator. Preferably, the step of concentrating the saccharide feed is carried out after step (a) and before step (b).

In some examples, the product of the spray drying step set out in step (i) is cooled. Preferably, the product of the spray drying step set out in step (i) is cooled immediately after spray drying is completed. Preferably, the product of the spray drying step set out in step (i) is cooled to a temperature of at most 60° C., or, at most 50° C., or, at most 40° C., or, at most 30° C. Preferably, the product of the spray drying step set out in step (i) is cooled to a temperature of from 25 to 40° C., or, 30 to 35° C.

### The Resistant Dextrin in a Composition

Another aspect of the present invention relates to a resistant dextrin in a composition.

In some examples, the composition comprises the resistant dextrin and water. Preferably, the composition comprises the resistant dextrin at from 55 to 98 weight %, or, from 60 to 90 weight %, or, from 65 to 85 weight %, or, from 70 to 80 weight %, or, at 72 weight %; the balance at each weight % being essentially water. More preferably, the composition comprises the resistant dextrin at from 60 to 75 weight %, or, from 65 to 75 weight %, or, from 67.5 to 72.5 weight %, or, from 70 to 72 weight %, or, at 71 weight %: of, from 76 to 86 weight %, or, from 74 to 85 weight %, or, from 75 to 84 weight %, or, from 78 to 82 weight %; the balance at each weight % being essentially water.

### Method of Producing the Resistant Dextrin in a Composition

Another aspect of the present invention relates to a method of making the resistant dextrin present in a composition. The method of making the composition comprises the steps:
(a) providing a resistant dextrin;
(c) combining the resistant dextrin with water to form a composition.

In some examples, water is added to the resistant dextrin until the composition comprises the resistant dextrin at from 55 to 98 weight %, or, from 60 to 90 weight %, or, from 65 to 85 weight %, or, from 70 to 80 weight %, or, at 72 weight %: the balance at each weight % being essentially water. More preferably, water is added to the resistant dextrin until the composition comprises the resistant dextrin at from 60 to 75 weight %, or, from 65 to 75 weight %, or, from 67.5 to 72.5 weight %, or, from 70 to 72 weight %, or, at 71 weight %: of, from 76 to 86 weight %, or, from 74 to 85 weight %, or, from 75 to 84 weight %, or, from 78 to 82 weight %: the balance at each weight % being essentially water.

### Method of Forming a Resistant Dextrin (in Liquid Form)

Another aspect of the present invention relates to a method of forming a resistant dextrin in liquid form.

In some examples, the method of forming a resistant dextrin in liquid form comprises the following steps:
(a) providing a saccharide feed comprising at least 35 weight %, or, at least 45 weight %, or, at least 55 weight % on a dry solid basis of dextrose and/or dextrose oligomers;
(b) heating the saccharide feed to a temperature of at least 60° C.;
(c) adding an acidifying catalyst to form an acidic composition;
(d) heating the acidic composition up to at least 120° C., or, at least 140° C., or at least 180° C., or, at least 190° C.;
(e) injecting the acidic composition through a first microdevice to react the dextrose and/or dextrose oligomers with the acid catalyst in the presence of water for a time sufficient to produce a first reacted composition wherein at least 60 weight %, or at least 70 weight %, or, at least 80 weight %, or, at least 85 weight % of the dextrose and/or dextrose oligomers have reacted, and wherein the first reacted composition comprises from 60 to 90 weight %, or, from 70 to 80 weight %, or, 75% weight dry solids;
(f) extracting the water from the first reacted composition to obtain a water-depleted composition comprising at least 90 weight %, or, 95 weight %, or, 98 weight % dry solids;
(g) injecting the water-depleted composition through a second microdevice to react any non-reacted dextrose and/or dextrose oligomers with the acid catalyst at a temperature of at least 160° C., or, 180° C., or, 200° C., or, at least 210° C., or, at least 220° C. for a time sufficient to produce a second reacted composition wherein at least 90 weight %, or, at least 92 weight % of the dextrose and/or dextrose oligomer have reacted, and wherein the second reacted composition comprises from 60 to 80 weight %, or, from 65 to 75 weight %, or, 70 weight % dry solids; and/or
(h) refining the second reacted composition to form the resistant dextrin in liquid form.

Preferable features of steps (a), (b), (c), (d), (e), (f), (g) and (h) are as defined above under the sub-heading “Method of producing the resistant dextrin (in particulate form)”.

In some examples, the resistant dextrin in liquid form comprises a resistant dextrin and water. Preferably, the resistant dextrin in liquid form comprises the resistant dextrin at from 60 to 75 weight %, or, from 65 to 75 weight %, or, from 67.5 to 72.5 weight %, or, from 70 to 72 weight %, or, at 71 weight %; the balance at each weight % being essentially water.

The method of forming a resistant dextrin in liquid form may further comprise the step of;
(i) drying the resistant dextrin in liquid form to produce a partially dried resistant dextrin in liquid form, preferably, wherein the partially dried resistant dextrin in liquid form comprises resistant dextrin at from 76 to 86 weight %, or, from 74 to 85 weight %, or, from 75 to 84 weight %, or, from 78 to 82 weight %: the balance at each weight % being essentially water. This may be desirable to form a more concentrated resistant dextrin in liquid form.

During step (i), the resistant dextrin in liquid form is preferably partially dried by using an evaporator which operates under vacuum. Preferably, the evaporator used is a plate or agitated thin film evaporator. Preferably, the evaporator is operated so that evaporation happens at a low temperature (below 70° C.) and within a short residence time (from seconds to a three minutes). Advantageously, use of the evaporator to form the partially dried resistant dextrin in liquid form limits color formation during the drying step.

During step (i), the resistant dextrin in liquid form is preferably partially dried by using spray drying. Another method of partially drying includes, but is not limited to, belt drying. Examples of devices that can be used to spray dry the resistant dextrin in liquid form include, but are not limited to, dual fluid nozzle spray dryer, single fluid nozzle spray dryer, rotary atomizer spray dryer, high-pressure nozzle spray dryer, and/or steam-assisted atomization spray dryer, small scale spray drying devices such as Buchi (Buchi, CH) spray dryer and a pilot scale spray dryer such as Niro MOBILE MINOR™, Anhydro PSD55 spray dryer equipped with rotary atomizer, Model MM-IN spray dryer and large scale drying devices such as co-current with integrated belt and nozzle atomizer (such as Filtermat™), co-current conical base with rotary atomizer (such as a single stage spray dryer), co-current with nozzle atomizer (such as Toll FORM DRYER), mixed flow spray dryer with integrated fluid bed and rotary or nozzle atomizer (such as fluidized Spray Dryer FSD™), mixed flow spray dryer with integrated filter and fluid bed and rotary or nozzle atomizers (such as integrated Filter Dryer IFD™).

During step (i), the step of partially drying the resistant dextrin in liquid form is performed for a sufficient amount of time until the partially dried resistant dextrin in liquid form comprises resistant dextrin at from 76 to 86 weight %, or, from 74 to 85 weight %, or, from 75 to 84 weight %, or, from 78 to 82 weight %; the balance at each weight % being essentially water.

During step (i), the resistant dextrin in liquid form can be partially dried by using spray drying, during which the temperature is controlled: the temperature at which the spray drying is performed can control the moisture content of the resultant product because a higher temperature will allow a drier product to be obtained. The temperature at which the spray drying is conducted is from 60 to 130° C., or, from 60 to 120° C., or, from 65 to 100° C., or, from 75 to 110° C., or, from 75 to 115° C., or, from 80 to 120° C., or, from 85 to 130° C. Alternatively, the temperature at which the spray drying is conducted is from 125 to 250° C., or, from 125 to 185° C., or, from 125 to 160° C., or, from 130 to 150° C., or, from 150 to 250° C., or, from 150 to 225° C., or, from 150 to 200° C., or, from 175 to 250° C., or, from 175 to 225° C., or, from 200 to 250° C.

During step (i), the resistant dextrin in liquid form can be partially dried using spray drying. When partially drying the resistant dextrin in liquid form with a spray dryer, spray drying conditions such as outlet temperature, the concentration of solids in the resistant dextrin in liquid form, the particle size desired in the resultant product, the period of time in which the resistant dextrin in liquid form is exposed to the spray drying device and if it would be beneficial to dry the particles during flight are considered. A high outlet temperature is beneficial if quick drying of the resistant dextrin in liquid form is desired. To control the outlet temperature, parameters such as, but not limited to, inlet air temperature, feed solids, air flow, feed temperature and flow rate are varied. With regard to concentration, a 50 to 55 weight %, or, 50 to 52 weight % dry solid concentration is required to ensure that water can be evaporated at a reasonable temperature and residence time. A 50 to 87 weight %, or 60 to 80 weight %, or, 65 to 75 weight %, or 67 to 73 weight %, or, 70 to 72 weight %, or 71 weight % of dry solid concentration is required to ensure that water can be evaporated at a reasonable temperature and residence time if the spray dryer is able to pulverize the liquid material. This solid concentration content depends on the spray system capability of the spray dryer. The spray system should avoid forming cotton candy structures by forming elongated droplets (filaments). Such cotton candy structures have poor flowability, and consequently it is difficult for these filaments to flow out of the drying chamber. The solid concentration and the feed temperature are the best parameters to ensure good pulverization of the feed. Increasing the feed temperature and decreasing the solid concentration enable the decrease of the feed viscosity and make the pulverization easier. If the resistant dextrin in liquid form contains too much water then the resistant dextrin in liquid form may not dry quickly enough, and may become sticky and agglomerate with other particles or stick to equipment surfaces. Furthermore, regarding concentration, a low solid concentration (for example a concentration of 30 to 40 weight % dry solids) can lead to smaller particle sizes (for example particles with a D50 of from 40 μm or below) in the resultant product. Another way to control the particle size of the resultant product is to select the nozzle size used on the spray dryer: the nozzle can influence the size of droplets formed, and therefore influence the size of the particles finally formed. Drying the particles during flight is beneficial if the particles are likely to agglomerate with other particles upon settling on a surface.

During step (i), the resistant dextrin in liquid form can be partially dried by using spray drying, during which the spray dryer can be fitted with a nozzle, such as a high-pressure nozzle. The nozzle aids the atomization of the resistant dextrin in liquid form. Alternatively, other techniques can be used to achieve atomization of the resistant dextrin in liquid form such as, but not limited to, steam-assisted atomization. To atomize the resistant dextrin in liquid form with steam-assisted atomization, the resistant dextrin in liquid form is mixed with steam in a nozzle which results in the production of very finely atomized droplets. Advantageously, the very finely atomized droplets provide particles with the size and narrow particle size distribution required in the resultant product. Further advantageously, steam-assisted atomization produces particles which are spherical, or almost spherical, because the particles do not collide so frequently during formation and do not dry during droplet formation. Methods of using and examples of atomization devices are further described in WO2005/079595, WO03/090893 and WO01/45858.

In some examples, a resistant dextrin in liquid form is obtained, or obtainable, by the above method.

### The Resistant Dextrin (in Particulate Form and or Liquid Form) in a Food or Beverage Product

Another aspect of the present invention relates to a resistant dextrin in a food or beverage product.

The resistant dextrin can be used in a food or beverage product. Optionally, the food or beverage product also comprises proteins, hydrocolloids, starches, bulking agents, such as sugar alcohols or maltodextrins: sweeteners, such as sucrose, HFCs, fructose and/or high intensity sweeteners.

The resistant dextrin can be used in a food or beverage product as a tenderizer or texturizer (for example to improve the crispness of a product), a humectant (for example to improve product shelf life and/or to produce a soft or moist texture), an agent that reduces water activity, replaces egg wash, improves sheen of a product, to replace fat in a product, to alter flour starch gelatinization temperature, to modify texture of the product and/or to enhance browning of a product.

In some examples, the resistant dextrin is present in the food or beverage product, or in a phase of the food or beverage product, which comprises at most 3.5 weight %, or, at most 3.0 weight %, or, at most 2.5 weight %, or, at most 2.0 weight %, or, at most 1.5 weight % water. Advantageously, as a result of the food or beverage product, or phase of the food or beverage product, containing a low weight % of water, the resistant dextrin does not dissolve. The resultant food or beverage product therefore has an improved mouthfeel.

In some examples, the resistant dextrin is present in a food or beverage product, or in a phase of the food or beverage product, which comprises at least 10 weight %, or, at least 20 weight %, or, at least 30 weight %, or, at least 50 weight % water. The resistant dextrin can also be present in a food or beverage product, or in a phase of the food or beverage food product, which is a dry mix to which a liquid, such as water, is added. Examples of dry mixes include, but not limited to powders for fruit beverages, protein beverages, meal replacements, milk, milk modifiers, batters, puddings, soups, gravies and sauces.

In some examples, the resistant dextrin is incorporated into a confectionary food product, which includes but is not limited to chocolate. Examples of the chocolate in which resistant dextrin can be incorporated includes but is not limited to milk chocolate, bittersweet chocolate, dark chocolate and white chocolate. Other ingredients present in the chocolate include, but are not limited to, sweeteners such as sugar and non-sugar sweeteners, cocoa liquor, cocoa butter, dairy ingredients, vegetable fats and/or emulsifiers.

In some examples, the resistant dextrin is incorporated into a confectionary coating food product. Other ingredients present in the confectionary coating food product include, but are not limited to, sweeteners, cocoa butter cocoa powder or cocoa butter equivalents, vegetable fats, emulsifiers and/or flavorings such as, but not limited to, yoghurt, strawberry, vanilla, white chocolate, mint, peanut butter and/or raspberry. The confectionary coating food product can be used in, but not limited to use in, baked goods.

In some examples, the resistant dextrin is incorporated into a chocolate filling food product. Examples of the chocolate filling food product includes a chocolate filling placed within a chocolate shell, and/or a chocolate filling within baked goods such as cake, brownies, cookie crisps, muffins, breads, sweet doughs, pastries, biscuits and/or cookies.

In some examples, the resistant dextrin is incorporated into a fatty spread food product. Examples of the fatty spread food product include, but are not limited to, nut-based spreads such as peanut butter, almond butter and cashew butter, sweetened nut spreads such as sweetened hazelnut spreads, milk-based spreads and/or chocolate-based spreads.

In some examples, the resistant dextrin is incorporated into sweet food products such as sweets and/or candy bars which include, but are not limited to, energy bars, snack bars, breakfast bars and/or protein bars.

In another example, the resistant dextrin is incorporated into sugar glasses in the amorphous state. The sugar glasses can be, but are not limited to, used to adhere to baked goods and/or to form a film or coating which enhances the appearance of a baked good.

In some examples, the resistant dextrin is incorporated into a fermented beverage. The fermented beverage may contain ethanol, preferably no more than 50 weight %, or, no more than 15 weight %, or, no more than 10 weight %, or, no more than 8 weight % ethanol. The fermented beverage can be, but is not limited to, beer, such as ale or lager, cider, mead, wine, rice wine, sake, kombucha drink or a sauerkraut juice.

Other possible food and/or beverage products the resistant dextrin can be incorporated into includes, but is not limited to, frozen dessert, chewing gum, centerfill confections, mediated confectionary, lozenges, tablets, pastilles, mints, standard mints, power mints, chewy sweets, hard sweets, boiled sweets, breath and oral care films or strips, candy canes, lollipops, gummies, jellies, wine gums, fudge, caramel, hard and soft panned goods, fruit snacks, toffee, taffy, liquorice, gelatin sweets, gum drops, jelly beans, nougats, fondants, meat analogue, bread, cake, cookies, crackers, extruded snacks, soup, fried food, pasta product, potato product, rice product, corn product, wheat product, dairy product, breakfast cereal, anhydrous coatings (for example, ice cream compound coating and chocolate), syrups, jams and jellies, beverages, clear-water, ready-to-drink beverages, protein beverages, toaster paninis, donuts, fillings, extruded and sheeted snacks, gelatin desserts, cheese, cheese sauces, liquid and dry coffee creamers, lower milk solids cheese, lower fat cheese, calorie reduced cheese, milk alternatives such as but not limited to nut-based milk alternatives and oat-based milk alternatives, smoothies, ice cream, shakes, cottage cheese, cottage cheese dressing, dairy desserts, edible and water-soluble films, dressings, creamers, icings, frostings, glazes, dry and moist pet food, tortillas, puffed snacks, corn chips, meat, fish, dried fruit, infant and toddler food, batters, sauces, condiments, ketchup, mayonnaise, and/or breadings such as batters and breadings for meat.

Advantageously, the resistant dextrin is added to the food and/or beverage products to provide a source of soluble fiber. The resistant dextrin can, advantageously, increase the fiber content of the food and/or beverage products without damaging the flavor, mouth feel or texture of the resultant food and/or beverage product. The resistant dextrin can be added to the product and/or beverage optionally together with fructo-oligosaccharides, polydextrose, inulin, maltodextrin, resistant starch, starch, sucrose, and/or conventional corn syrup solids. The resistant dextrin can be used as a replacement for from 0 to 100 weight % of the fiber in the food and/or beverage product. Thus, the resultant food or beverage product contains from 0 to 100% less sugar.

Advantageously, the resistant dextrin is added to the food and/or beverage product to act as a sweetener. The resistant dextrin is suitable for complete or partial replacement with other sweeteners such as high fructose corn syrup, fructose, dextrose, regular corn syrup, corn syrup solids, sweet potatoes such as Brazzein and/or Thaumatin, tapioca syrup, oat syrup, rice syrup and/or pea syrup. Upon replacing the sweetener with resistant dextrin, the sugar level is reduced but the mouthfeel and flavor remain the same, or substantially the same. The resistant dextrin can be used as a replacement for from 0 to 100 weight % of the sweetener in the food and/or beverage product.

Advantageously, the resistant dextrin is added to the food and/or beverage product to act as a bulking agent. The resistant dextrin is suitable for complete or partial replacement with other bulking agents and can therefore replace fat, flour, sugar alcohols, maltodextrins and/or other bulking agents present. Upon replacing the bulking agent with resistant dextrin, the caloric level is reduced, nutritional profile of the product improved and the mouthfeel and flavor remain the same, or substantially the same. The resistant dextrin can be used as a replacement for from 0 to 100 weight % of the bulking agent in the food and/or beverage product.

Advantageously, the resistant dextrin is added to the food and/or beverage product to control or improve the blood glucose concentrations in humans and animals that suffer from diabetes. When the human or animal digest the food and/or beverage containing the resistant dextrin, the resistant dextrin can cause a more moderate relative glycemic response in the blood steam.

### Method of Producing the Resistant Dextrin (in Particulate Form and or Liquid Form) in a Food or Beverage Product

Another aspect of the present invention relates to a method of making the resistant dextrin present in a food or beverage product. The method of making the food or beverage product comprises the steps:
(a) providing the resistant dextrin; and
(b) combining the resistant dextrin with at least one food or beverage product.

### The Resistant Dextrin May be Used (in Particulate Form and or Liquid Form) in a Composition Requiring a Thickening Agent.

Another aspect of the present invention relates to a resistant dextrin in a composition requiring a thickening agent.

In some examples, the composition requiring a thickening agent includes, but is not limited to, personal care compositions such as cosmetic products, face and/or body creams, face and/or body lotions and toothpaste, as well as paints, inks and/or printing products such as printing ink.

In some examples, the composition requiring a thickening agent is an ecofriendly alternative which replaces microplastics such as polyethylene, polymethylmethacrylate or nylon.

### Method of Producing the Resistant Dextrin (in Particulate Form and or Liquid Form) in a Composition Requiring a Thickening Agent

Another aspect of the present invention relates to a method of making a resistant dextrin in a composition requiring a thickening agent. The method of making the composition requiring a thickening agent comprises the steps:
(a) providing the resistant dextrin; and
(b) combining the resistant dextrin with at least one composition requiring a thickening agent.

### EXAMPLES

The following are non-limiting examples that discuss, with reference to tables, the advantages of the present invention. The examples set forth herein are non-limiting examples and are merely examples among other possible examples.

In the following examples, resistant dextrin of the present invention was evaluated. To provide a comparison, other commercially available fiber samples were also evaluated. The tested fiber samples include Promitor SGF 70 R, Promitor NGR 85, Fibersol-2 NONGMO, Nutriose FM10, Nutriose FM6 and Frutafit® HD.

### Example 1: Making the Resistant Dextrin (in Particulate Form)

A resistant dextrin according to the present invention was prepared. The resistant dextrin produced is referred to as “Cargill resistant dextrin 1” in the present examples.

In this non-limiting example, the following steps were followed to prepare the Cargill resistant dextrin 1:
(a) providing a saccharide feed comprising at least 55 weight % on a dry solid basis of dextrose and dextrose oligomers;
(b) heating the saccharide feed to a temperature of at least 60° C.;
(c) adding an acidifying catalyst to form an acidic composition;
(d) heating the acidic composition up to at least 190° C.;
(e) injecting the acidic composition through a first microdevice to react the dextrose and/or dextrose oligomers with the acid catalyst in the presence of water for a time sufficient to produce a first reacted composition wherein at least 85 weight % of the dextrose and/or dextrose oligomers have reacted, and wherein the first reacted composition comprises at least 60% weight dry solids;
(f) extracting the water from the first reacted composition (also referred to as “first intermediate product”) to obtain a water-depleted composition comprising at least 98 weight % dry solids;
(g) injecting the water-depleted composition through a second microdevice to react any non-reacted dextrose and/or dextrose oligomers with the acid catalyst at a temperature of at least 220° C. for a time sufficient to produce a second reacted composition wherein at least 92 weight % of the dextrose and/or dextrose oligomer have reacted, and wherein the second reacted composition comprises from at least 70 weight % dry solids;
(h) refining the second reacted composition to form a refined second reacted composition; and
(i) drying the refined second reacted composition by spray drying to produce the Cargill resistant dextrin 1.

### Example 2: Measuring the D10, D90, D50 and SPAN of the Cargill Resistant Dextrin 1

The following non-limiting example describes how the D10, D90, D50 and SPAN of the “Cargill resistant dextrin 1” were measured.

In this non-limiting example, the particle size distribution of the “Cargill resistant dextrin 1” was measured by laser light diffraction by using a Mastersizer 3000 (Malvern). The equipment allows the measurement of particles with sizes ranging from 0.1 to 3500 μm. The equipment uses a Helium Neon red laser (633 nm, max 4 mW), a blue LED light source (10 mW 470 nm) and a wide angle detection stem (0.015-144 degrees). The equipment additionally uses an Aero S automated dry powder dispersion system with a venturi disperser.

Prior to sample measurement, a background measurement was taken. The background measurement was taken for a duration of 10 s or longer.

The settings used for the sample measurement were set as follows:
Particles type: Non spherical
Measurement duration: Background: 10 seconds, and the sample measurement: 30 seconds
Obscuration range: [0.5%-8%]
Air pressure: 2 bars
Feed rate: 45%
Feeder gap: 1 mm
Calculation: Mie theory
Amount of sample: 20 g

Three measurements of the sample were taken, and the average value retained.

The particle size distribution was calculated from the intensity profile of the scattered light with Mie theory, by use of the software installed on the Mastersizer 3000. The following parameters, among others, were automatically generated by the software: D10, D50, D90 and SPAN. The results are displayed in Table 3.

To provide a comparison, the D10, D90, D50 and SPAN of Promitor SGF 70 R, Promitor NGR 85, Fibersol-2 NONGMO, Nutriose FM10, Nutriose FM6 and Frutafit® HD were also measured in the same way. The same procedure as carried out with the Cargill resistant dextrin 1 was used with the additional samples. The results are displayed in Table 3.

TABLE 3
The D10, D90 and D50 and SPAN values
of the evaluated samples.

| Sample | D10 (μm) | D50 (μm) | D90 (μm) | SPAN |
|---|---|---|---|---|
| Cargill resistant dextrin 1 | 17.4 | 43.0 | 79.5 | 1.4 |
| Promitor SGF 70 R | 16.3 | 129.2 | 430.3 | 3.2 |
| Promitor NGR 85 | 10.6 | 54.3 | 163.0 | 2.8 |
| Fibersol-2 NONGMO | 13.2 | 40.9 | 85.9 | 1.7 |
| Nutriose FM10 | 13.1 | 99.1 | 227.8 | 2.16 |
| Nutriose FM6 | 25.0 | 148.0 | 358.7 | 2.25 |
| Frutafit ® HD | 10.8 | 43.9 | 109.3 | 2.2 |

Advantageously, the Cargill resistant dextrin 1 has low D10, D50, D90 and the lowest SPAN values.

For at least chocolate products, particle size distribution affects both flow properties and sensory perception. The flow behavior is important in moulding and enrobing operations. Sensory perception is important for the acceptance of the final product by the consumer.

When chocolate products are manufactured, all the dry ingredients (which include solid particles) are typically ground to below 30 microns to avoid the chocolate tasting gritty. The Cargill resistant dextrin 1 comprises generally spherical particles with sizes from 0.1 to 100 microns. A portion of the generally spherical particles can be broken to achieve a size below 30 microns. Without wishing to be bound by theory, when starting from a powder with a narrow distribution (i.e., relatively low SPAN), the grinding/refining steps reduce the size of the larger particles (which are at a size of from 30 to 100 microns) to below 30 microns. The creation of broken particles results in a larger particle size distribution. The resultant particles comprise broken random shape particles and spherical non-broken particles. The newly obtained population of particles is suitable for efficient packing in chocolate products.

The resultant population of particles of Cargill resistant dextrin 1 will be coated in fat when forming chocolate products. With the efficient packing of the particles, less fat will be required when forming chocolate products. As a result, the following beneficial properties will be found in the chocolate products where the Cargill resistant dextrin has a SPAN value of at most 2.7 (or at most 2.15, or, at most 2, or, at most 1.8, or, at most 1.6, or, at most 1.4):
1. Chocolate flow properties: every gram of free fat not used for coating the newly formed particles will reduce the viscosity and the yield of the chocolate products.
2. Sensory perception: every gram of free fat not used for coating the particles of Cargill resistant dextrin 1 will positively influence the creaminess and the melting profile of the chocolate products. The presence of non-broken particles (the particles which have kept their original spherical morphology) positively influences the smoothness of the chocolate products.
3. Cost effectiveness: It is often desirable for chocolate manufacturers to have as low a viscosity as possible with a minimum addition of one of its most expensive bulk ingredients-cocoa butter (fat).

### Example 3: Measuring the BET of the Cargill Resistant Dextrin 1

The following non-limiting example describes how the BET of the Cargill resistant dextrin 1 was measured. The BET could be evaluated from an N₂ sorption isotherm (measured at the boiling point of liquid N₂) using the BET model (Brunauer, Emmett and Teller, corrected single layer theory applicable in the linear region of BET plot).

In this non-limiting example, the BET of the Cargill resistant dextrin 1 was measured on a Micromeritics Gemini VII 390 Surface Area Analyzer. The equipment used a BET model corrected based on the single layer theory applicable in the linear region of a BET plot (absorbed volume of gas as a function of relative pressure). The device operated at a temperature of −196.15° C., the boiling point of liquid nitrogen) and a pressure difference of from 0 to 0.3. The gas used in the measurements was nitrogen.

Initially, the Cargill resistant dextrin 1 was weighed in glass tubes with a 19.1 mm OD bulb×155 mm long, Micromeritics. The sample tube and its contents were loaded into the degassing port of a degassing device (VacPrep061, Micromeritics, USA) operating at 40° C., and were left for 12 hours. The purpose of this thermal pre-treatment was to drive off any physi-sorbed water on the sample, whilst leaving the morphology of the sample unchanged. Once the preparation was completed, the sample was allowed to cool down to room temperature (20.0±2° C.). The sample tube and its contents were then re-weighed to obtain the dry weight of the sample. This value was entered into the necessary section of the software program for further calculations. The sample tube was then transferred to the analysis port.

A tube similar to the one containing the sample but filled with glass beads so the volume occupied by the glass beads was equal to sample volume, was used as a reference.

During measurement, sample and reference tubes were immersed in liquid nitrogen at −196.15° C. before the adsorption measurements started. The relative pressure (P/P₀) was changed stepwise from 0 to 0.99 to obtain the whole sorption isotherm. The software controlling the automated apparatus performed a leak-checking procedure and an equilibration time of 5 s was used for each adsorption point. One replicate was measured for each sample.

The BET isotherm equation (below) can be plotted as a straight line with 1/[Vₐ×(P₀/P−1)] on the y-axis and P/P₀ on the x-axis, according to experimental results.

$$\frac{1}{{V}_{a} \times ( \frac{{P}_{0}}{P} - 1 )} = \frac{C - 1}{{V}_{m} \times C} \times \frac{P}{{P}_{0}} + \frac{1}{{V}_{m} \times C}$$

wherein P=partial vapor pressure of adsorbate gas in equilibrium with the surface at −196.15° C.; P₀=saturated pressure of adsorbate gas (Pa): Vₐ=volume of gas adsorbed at standard temperature and pressure (m³): Vₘ=volume of gas adsorbed at standard temperature and pressure to produce an apparent monolayer on the sample surface (m³): C=dimensionless constant that is related to the enthalpy of adsorption of the adsorbate gas on the sample.

The linear relationship of this equation is valid only in the range of 0.05<P/P₀<0.35. The value of the slope [(C−1)/Vₘ×C] and the y-intercept 1/Vₘ×C were used to calculate the monolayer adsorbed gas quantity Vₘ and the BET constant C (as shown in the following two equations), respectively).

$${V}_{m} = \frac{1}{slope + intercept} \\ C = 1 + \frac{slope}{intercept}$$

The specific surface S_{spec} (BET value) was then obtained from the following equation:

$${S}_{Spec} = \frac{{V}_{m} \times N \times s}{V \times a}$$

wherein S_{spec}=specific surface (m²/g): Vₘ=volume of gas adsorbed at standard temperature and pressure to produce an apparent monolayer on the sample surface (m³): N=Avogadro's number, s=adsorption cross-sectional area of nitrogen (0.162 10⁹ m²): V=molar volume of the adsorbate gas (22.414 10⁻³ m³·mol⁻¹): a=mass of the sample (g).

To provide a comparison, the BET values of Promitor SGF 70 R, Promitor NGR 85, Fibersol-2 NONGMO, Nutriose FM10, Nutriose FM6 and Frutafit® HD were also measured in the same way. The same procedure as carried out with the Cargill resistant dextrin 1 was used with these additional samples. The results are displayed in Table 4.

TABLE 4
The BET values of the evaluated samples.

| Sample | BET (m²/g) |
|---|---|
| Cargill resistant dextrin 1 | 0.15 |
| Promitor SGF 70 R | 0.16 |
| Promitor NGR 85 | 0.33 |
| Fibersol-2 NONGMO | 0.23 |
| Nutriose FM10 | 0.15 |
| Nutriose FM6 | 0.21 |
| Frutafit ® HD | 0.28 |

Advantageously, the Cargill resistant dextrin 1 has a low BET value. Advantageously, a low BET value provides improved smoothness and enhanced mouthfeel in the resultant product in particular when combined with low D10, D50, D90 and SPAN values. Further advantageously, a low BET value results in a product having improved flow properties which aids processing and material handling.

### Example 4: Measuring the OBC of the Cargill Resistant Dextrin 1

The following non-limiting example describes how the OBC of the Cargill resistant dextrin 1 was measured.

In this non-limiting example, the OBC of the Cargill resistant dextrin 1 was measured by dispersing 2.5 g (weight 1=W₁) of the Cargill resistant dextrin 1 in 50 g (weight 2=W₂) of sunflower oil (VDM 15X1L from Vandemoortele Europe NV) and mixing for 10 minutes at room temperature (25.0±2.0° C.) and at a rpm of 500 using a magnetic stirrer (IKA RCT Basic) and 150 ml Scott Duran glass baker (Ø 6.0 cm, height 8.0 cm) until complete product dispersion. After a rest period of 30 minutes, the Cargill resistant dextrin 1 was stirred again for 1 minute at a rpm of 500 rpm with a magnetic stirrer IKA and at room temperature (25.0±2.0° C.). Then 45 g of the suspension was poured into a tube in a centrifuge. The tube used was a 50 ml self-standing polypropylene tube with a plug seal cap from Corning Inc. 430897. The weight of the tube was weight before (weight 3=W₃) and after (weight 4=W₄) addition of the suspension. The samples were then centrifuged for 5 minutes at 3000 rpm at room temperature (25.0±2.0° C.). The centrifuge used was a Labofuge 400m Heraeus. Upon centrifugation, the supernatant and residue separated. Removal of the oil ensures that the oil height above the residue is below 0.1 mm after resting the residue for 5 minutes. Removal of the oil is done so that residue is not mixed with residue when the supernatant is removed.

The supernatant was removed, and the weight of the centrifuge tubes containing the residue weighed (weight W5). The weight of the supernatant and residue were then compared by applying the following equation:

$$O B C = \frac{{W}_{OB}}{{W}_{CP}}$$

Wherein the percentage of product in start oil mixture is

$${W}_{P} = \frac{{W}_{1} \times 100}{{W}_{1} + {W}_{2}} ,$$

the percentage of oil in start oil mixture is

$${W}_{O} = \frac{{W}_{2} \times 100}{{W}_{1} + {W}_{2}} ,$$

the product weight is

$${W}_{CP} = \frac{{W}_{P}}{100} \times ( {W}_{4} - {W}_{3} )$$

and the oil bind is W_{OB}=W₅−W₃−W_{CP}.

The results of the experiment are displayed in Table 5.

To provide a comparison, the OBC values of Promitor SGF 70 R, Promitor NGR 85, Fibersol-2 NONGMO and Frutafit® HD were also measured in the same way. The same procedure as carried out with the Cargill resistant dextrin 1 was used with these additional samples. The results are displayed in Table 5.

TABLE 5
The OBC values of the evaluated samples.

| Sample | OBC (g/g) |
|---|---|
| Cargill resistant dextrin 1 | 1.12 |
| Promitor SGF 70 R | 0.53 |
| Promitor NGR 85 | 1.02 |
| Fibersol-2 NONGMO | 1.45 |
| Nutriose FM10 | 1.68 |
| Nutriose FM6 | 1.90 |
| Frutafit ® HD | 1.33 |

Advantageously, the Cargill resistant dextrin 1 has an optimal OBC value. If the OBC value is too low, then the resistant dextrin will not attract any oil and cannot be used to influence any properties of the resultant product in which the resistant dextrin is used in. If the OBC value is too high, then the resistant dextrin will attract a lot of oil and the resultant product will be too viscous.

Advantageously, the Cargill resistant dextrin 1 has an optimal (intermediate) OBC value. The Cargill resistant dextrin 1 is therefore able to mix well with oil and will therefore be particularly beneficial when used to manufacture fat-based products such as fillings or chocolate.

### Example 5: Measuring the Wettability of the Cargill Resistant Dextrin 1

The following non-limiting example describes how the wettability of the Cargill resistant dextrin 1 was measured.

In this non-limiting example, the wettability of the Cargill resistant dextrin 1 was measured by measuring the time required for a known amount of the resistant dextrin to completely penetrate the still surface of water at a known temperature. In this non-limiting example, 250 ml of water at 25° C. was poured into a 400 ml beaker. The weight of the water and beaker was then weighed, the weighing scale used had a precision of 0.01 g. A metal plate (having the dimensions of 12 cm square sides) was placed between the glass beaker containing the water and a metal cylinder (having the dimensions of diameter 8.5 cm, height 6.5 cm). Then, 10 g of the Cargill resistant dextrin 1 was weighed out. Once weighed, the Cargill resistant dextrin 1 was poured evenly into the metal cylinder. At time zero, the metal plate was removed completely from beneath the cylinder and the time taken for the Cargill resistant dextrin 1 to completely penetrate the water was measured. When measuring wettability with this method, it is usually considered acceptable if 10% of the Cargill resistant dextrin 1 is present at the surface of the water. Images were taken every five seconds up until 3 minutes from time zero until the powder was completely submerged in water. The time taken for the Cargill resistant dextrin 1 to completely penetrate the water is displayed in Table 6.

To provide a comparison, the wettability values of Promitor SGF 70 R, Promitor NGR 85, Fibersol-2 NONGMO, Nutriose FM10, Nutriose FM6 and Frutafit® HD were also measured in the same way. The same procedure as carried out with the Cargill resistant dextrin 1 was used with these additional samples. The time taken for each sample to completely penetrate the water is displayed in Table 6.

TABLE 6
The time taken for the samples to completely
penetrate water (i.e., wettability).

| Sample | Time (s) |
|---|---|
| Cargill resistant dextrin 1 | 4.00-4.66 |
| Promitor SGF 70 R | 2.00-2.00 |
| Promitor NGR 85 | 5.00-10.00 |
| Fibersol-2 NONGMO | >180.00 |
| Nutriose FM10 | 2.00-2.00 |
| Nutriose FM6 | 3.00-3.00 |
| Frutafit ® HD | 3.00-3.00 |

Advantageously, the Cargill resistant dextrin 1 has a low wettability.

### Example 6: Measuring the Color of the Cargill Resistant Dextrin 1

The following non-limiting example describes how the color of the Cargill resistant dextrin 1 of the present invention was measured.

In this non-limiting example, the color of the Cargill resistant dextrin 1 was measured as Hunter Lab colorimetric parameters (L, a, b) with a Chroma-meter CR410 (KONICA MINOLTA). The Chroma-meter was equipped with a measuring head CR-410, a white calibration plate CR-A44, a glass light-projection tube CR-A33e and a data processor DP-400.

The main characteristics of the measuring head are:
Illumination/viewing systems: Wide-area illumination/0° viewing angle (Specular component included);
Detector: Silicone photo cells (6);
Display range: Y: 0.01 to 160.00% (reflectance);
Light source: Pulsed xenon lamp;
Measurement time: 1 second;
Measurement/illumination area: Ø50/Ø53;
Observer: 2 degrees (closely matches CIE 1931 Standard Observers);
Illuminant: C, D65; and,
Display: Color difference values.

Initially, the Chroma-meter was calibrated by placing a white plate (calibration plate CR-A44) under the measuring head of the Chroma-meter. To determine the Hunter Lab colorimetric values of the samples, a beaker approximately half full of the Cargill resistant dextrin 1 as a powder was placed underneath the measuring head. The Chroma-meter then recorded the color of the sample. The Hunter Lab colorimetric parameters for the resistant dextrin are displayed in Table 7.

To provide a comparison, the colors of Promitor SGF 70 R, Promitor NGR 85, Fibersol-2 NONGMO, Nutriose FM10, Nutriose FM6 and Frutafit® HD were also measured in the same way. The same procedure as carried out with the Cargill resistant dextrin 1 was used with these additional samples. The Hunter Lab colorimetric parameters for the samples are displayed in Table 7.

TABLE 7
The Hunter Lab colorimetric parameters for the samples.

| Sample | L | a | b |
|---|---|---|---|
| Cargill resistant dextrin 1 | 96.7 | −1.3 | 3.5 |
| Promitor SGF 70 R | 93.5 | −1.6 | 8.0 |
| Promitor NGR 85 | 95.8 | −1.6 | 5.2 |
| Fibersol-2 NONGMO | 94.1 | −1.9 | 9.0 |
| Nutriose FM10 | 93.5 | −2.9 | 13.5 |
| Nutriose FM6 | 91.9 | −2.2 | 14.4 |
| Frutafit ® HD | 97.0 | −0.7 | 1.6 |

As can be seen from Table 7, the Cargill resistant dextrin 1 is very near to white, in color.

### Example 7: Measuring the Tg of the Cargill Resistant Dextrin 1

The following non-limiting example describes how the Tg of the Cargill resistant dextrin 1 of the present invention was measured.

In this non-limiting example, the Tg was measured at different moisture contents. Five samples of the Cargill resistant dextrin were analyzed. The samples were as follows:
Sample 1: without humidity adjustment (no treatment);
Sample 2: dried in thermogravimetric equipment in order to reach 0 weight % moisture. The drying was performed under the following conditions: drying gas: N₂; flow of drying gas: 50 ml/minute: drying temperature range: −25° C. to 240° C.: drying rate: 10° C./minute);
Sample 3: incubated at 50% relative humidity at 25° C. during 12 hours;
Sample 4: incubated at 60% relative humidity at 25° C. during 12 hours; and
Sample 5; incubated at 70% relative humidity at 25° C. during 12 hours.

After adjusting the moisture of the samples, the humidity was measured by thermogravimetric analysis (TGA) with a Mettler-Toledo (TGA/DSC 3+). The device was automatically calibrated prior to the measurements (linearity at three points, without external manipulation). Each sample was weighed into a 100 μL aluminum crucible from Mettler-Toledo by weighing 30 mg of each out into the crucible. The temperature of the thermogravimetric analysis device was set at 25° C. to 240° C. using a heating rate of 10° C./min. The flow of nitrogen in the thermogravimetric analysis device was set at 50 ml/min. The crucible containing the sample was placed into the thermogravimetric analysis device and the moisture content determined using Star software.

The Tg of each sample of was measured using differential scanning calorimetry on a TA instrument Q250 equipped with a RCS cooling system. The differential scanning calorimetry device was calibrated with indium and cyclohexane. The differential scanning calorimetry device was loaded with a 25 mg sample of the Cargill resistant dextrin 1. A double scan procedure was used to erase the enthalpy during the step of heating. After allowing equilibration at 0° C. to be reached, the sample was then heated up to 150° C.: during this step, a heating rate of 5° C. per minute was used. The sample was then cooled to 0° C., and then reheated up to 150° C.: during this step, a heating rate of 5° C. per minute was used. For all the experiments, TZERO, PANS was used to ensure that no moisture evaporation occurred. The Tg was detected during the second scan and is defined as the mid-point of the step change of the heat capacity. A Trios software, TA instrument was used to determine the Tg value. The Tg value at specific moisture content of the sample are displayed in Table 8.

To provide a comparison, the Tg values of Promitor SGF 70 R, Promitor NGR 85, Fibersol-2 NONGMO, Nutriose FM10, Nutriose FM6 and Frutafit® HD were also measured in the same way. The same procedure as carried out with the Cargill resistant dextrin 1 was used with the additional samples. The Tg value at specific moisture content of the sample are displayed in Table 8.

TABLE 8
The Tg (temperature in ° C.) for the samples
at varying moisture content (MC, weight %).

| | | | | | | |
|---|---|---|---|---|---|---|
| Frutafit ® HD | MC | 0.0 | 3.7 | 8.2 | 12.1 | / |
| | Tg | 141 | 64 | 33 | 16 | / |
| Fibersol-2 NONGMO | MC | / | 5.3 | / | 11.7 | 24.7 |
| | Tg | / | 100 | / | 43 | 18 |
| Promitor SGF 70 R | MC | 0.0 | 6.0 | 8.8 | 10.8 | / |
| | Tg | 152 | 63 | 38 | 19 | / |
| Promitor NGR 85 | MC | 0.0 | 4.8 | / | 11.1 | 20.6 |
| | Tg | 172 | 93 | / | 37 | 7 |
| Nutriose FM6 | MC | 0.0 | 8.3 | 9.0 | 10.8 | / |
| | Tg | 165 | 52 | 47 | 36 | / |
| Nutriose FM10 | MC | 0.0 | 6.7 | 7.5 | 11.5 | / |
| | Tg | 165 | 55 | 8 | 12 | / |
| Cargill resistant | MC | 0.0 | 5.5 | 8.8 | 37 | / |
| dextrin 1 | Tg | 142 | 68 | 37 | 17 | / |

As can be seen from Table 8, the Cargill resistant dextrin 1 has a low Tg value compared to other resistant dextrin and similar Tg to the one inulin sample.

### Example 8: Measuring the Monosaccharide and Disaccharide (DP1 and DP2) Content of the Cargill Resistant Dextrin 1

The following non-limiting example describes how the monosaccharide and disaccharide content of the Cargill resistant dextrin 1 was measured.

In this non-limiting example, the monosaccharide and disaccharide content of the Cargill resistant dextrin 1 was measured with HPLC chromatography. The column used was a H-column (30×0.78 cm). An example of such a column is a Rezex RHM-Monosaccharide by Phenomenex. The HPLC column was equipped with an autosampler, column oven, HPLC pump and refractive index detector. The eluent used in the column was a 0.001 N H₂SO₄ solution (0.1 N H₂SO₄ diluted 1:100 in HPLC grade water). During the experiments, the column temperature was maintained at 75° C., the flow rate was maintained at 0.6 ml/min and the refractive index maintained at ambient temperature.

The Cargill resistant dextrin 1 was made into a solution comprising 2-3 weight % of the Cargill resistant dextrin 1 in water. The solution was then injected into the HPLC, and the chromatogram obtained.

To determine the monosaccharide and disaccharide content, the area by % of the resultant chromatogram was analyzed. The monosaccharide and disaccharide content of the Cargill resistant dextrin 1 is displayed in Table 9. The values displayed are the sum of glucose and maltose peaks.

To provide a comparison, the monosaccharide and disaccharide content of Promitor SGF 70 R, Promitor NGR 85 and Fibersol-2 NONGMO was also measured in the same way. The same procedure as carried out with the resistant dextrin of the present invention was used with these additional samples. The monosaccharide and disaccharide content for the samples are displayed in Table 9.

TABLE 9
The monosaccharide and disaccharide content for the samples.

| | Monosaccharide and disaccharide | |
|---|---|---|
| Sample | content | |
| Cargill resistant dextrin 1 | 7.0 | weight % |
| Promitor SGF 70 R | 10.5 | weight % |
| Promitor NGR 85 | 4.0 | weight % |
| Fibersol-2 NONGMO | 1.5 | weight % |

As can be seen from Table 9, the Cargill resistant dextrin 1 has a monosaccharide and Disaccharide Content Comparable to Other Sugar Substitutes Available on the Market.

### Example 9: Measuring the Dextrose Equivalent of the Cargill Resistant Dextrin 1

The following non-limiting example describes how the dextrose equivalent of the Cargill resistant dextrin 1 was measured. Typical methods used to estimate the dextrose equivalent of a sample is based upon the ability of a sample to reduce metallic salts. One example of such a method is the Lane-Eynon procedure.

In this non-limiting example, the dextrose equivalent of the Cargill resistant dextrin 1 was measured by the Lane-Eynon procedure. In this procedure, dextrose and related sugars contained in the sample reduce copper sulfate in a controlled alkaline solution (Fehling's solution). The dextrose equivalent is measured as the total of reducing type sugars present in this sample, which are expressed as dextrose, and calculated as percentage of the dry sample.

The apparatus included a titrating assembly. The titrating assembly mounted a ring support on a ring stand 5 cm above a gas burner, and a second ring 18 cm above the first. An open wire gauze was placed 15 cm on the lower ring to support a 200 ml Erlenmeyer flask, and a 10 cm watch glass with a centre hole was placed on the upper ring to deflect heat. Then, a 25 ml burette was attached to the ring stand so that the tip just passed through the watch glass centred above the flask. An indirectly lighted white surface was then placed behind the assembly for observing the endpoint.

Two Fehling's solution were then prepared. The first solution was prepared by dissolving 69.3 g of copper sulphate pentahydrate (CuSO₄·5H₂O) in water and diluting to 1 litre. The solution was then filtered. The first solution was prepared by dissolving 346 g of potassium sodium tartrate tetrahydrate (KNaC₄H₄O₆·4H₂O) and 100 g of sodium hydroxide (NaOH) in water and diluting to 1 litre. The solution was then left overnight and filtered.

A sample dextrose solution was then prepared by drying a portion of National Bureau of Standards anhydrous dextrose [COH(CHOH)₄CH₂OH] in a vacuum oven at 100° C. for 1 hour. 1.200 g of the sample was then transferred to a 200 ml Kohlrausch flask, and dissolved with water, diluted to a desired volume and mixed.

The methylene blue indicator was then prepared by dissolving 1.0 g of water-soluble methylene blue dye (C₁₆H₁₈C₁N₃S·3H₂O) in 100 ml of water.

To a measured quantity of the first Fehling's solution, an identical quantity of the second Fehling's solution was added, and the resultant solution was mixed. Then 25.0 ml of this solution was placed into a 200 ml Erlenmeyer flask, glass beads were added, and the flask was placed on the wire gauze of the titration assembly. The burner was adjusted so that the boiling point was reached. Upon heating, the dextrose solution was added from the burette to about 0.5 ml before the endpoint. The mixture was brought to boiling and was boiled gently for 2 minutes. As the boiling continued, 2 drops of methylene blue indicator were added, and the titration was completed within 1 minute of this addition by adding the sugar solution dropwise until the blue colour disappeared.

The dextrose equivalent of the Cargill resistant dextrin 1 was then determined by preparing a solution as set out above. The solution was then transferred to a 200 ml Kohlrausch flask, and the Lane-Eynon procedure was conducted as described above.

The following calculations were then undertaken:

$$Reducing sugars of the sample dextrose solution ( \% ) = \frac{200 ml \times 0.12 \times 100 \%}{Titre , ml \times sample dextrose solution weight ( g )} \\ Dextrose equivalent = \frac{Reducing sugars of the sample dextrose solution ( \% ) \times 100}{Dry solid content of the Cargill reistsan dextrin 1 ( \% )}$$

The dextrose equivalent of the Cargill resistant dextrin 1 was determined to be 12 weight % on a dry solid basis.

### Example 10: Measuring the HMF and Furfural Content of the Cargill Resistant Dextrin 1

The following non-limiting example describes how the HMF and Furfural content of the Cargill resistant dextrin 1 was measured.

In this non limiting example, HPLC was carried out on a cation exchanger with

UV detection (operating at a wavelength of 284 nm). The conditions of the mobile phase was set as 0.0025m Ca(NO₃)₂-solution in degassed, demineralized water. The column used was a Bio-Rad HPX 87C, 30 cm×0.78 cm (equivalent is still useable), the column temperature was set as 65° C. and a flow rate of 0.7 ml/min was used.

The chemicals used in the experiment were: 5-HMF (CAS 67-47-0, min. 97%, e.g. Merck, Aldrich, Acros), 2-Furfural (CAS 98-01-0, min. 98%, e.g. Acros Chemicals) and Ca(NO₃)₂×4 H₂O (CAS 13477-34-4, e.g. Fisher Scientific, Merck).

The equipment was calibrated first, using standard solutions containing 50 to 150 ppm 5-Hydroxy Methyl Furfural (5-HMF) and 50 to 150 ppm 2-Furfural.

To determine the HMF and furfural content, a first standard solution containing 150 ppm HMF and a second standard solution containing 50 ppm Furfural were prepared. Then 20 μl of each standard solution were injected into the HPLC column. Then, a solution of the Cargill resistant dextrin 1 was prepared. The solution contained 20 weight 5 of the Cargill resistant dextrin 1 as dry solids. Then, 20 μl of the Cargill resistant dextrin 1 solution was injected into the HPLC column.

The HMF content was calculated with the following equation:

$$H M F ( ppm ) = \frac{area ( the Cargill resistant dextrin 1 ) \times ppm ( standard H M F ) \times 100}{\begin{matrix}area ( standard H M F ) \times weight \\ ( \text{} the Cargill resistant dextrin 1 in g of dry solids per 100 ml )\end{matrix}}$$

The HMF content of the Cargill resistant dextrin 1 was measured, and the results are displayed in Table 10. The Furfural content of the Cargill resistant dextrin 1 was measured with the same equation (HMF exchanged with furfural), and the results are displayed in Table 10.

To provide a comparison, the HMF content of Promitor SGF 70 R, Promitor NGR 85, Fibersol-2 NONGMO, Nutriose FM10, Nutriose FM6 and Frutafit® HD were also measured in the same way. The same procedure as carried out with the Cargill resistant dextrin 1 was used with these additional samples. The HMF and Furfural content for the samples are displayed in Table 10.

TABLE 10
The HMF and Furfural content for the samples.

| | HMF | Furfural |
|---|---|---|
| Sample | (ppm) | (ppm) |
| Cargill resistant dextrin 1 | <1 | <1 |
| Promitor SGF 70 R | 5.3 | <1 |
| Promitor NGR 85 | <1 | <1 |
| Fibersol-2 NONGMO | <1 | <1 |
| Nutriose FM10 | 10.5 | <1 |
| Nutriose FM6 | 2.1 | <1 |
| Frutafit ® HD | <1 | <1 |

Advantageously, as shown in Table 10, the Cargill resistant dextrin 1 has an extremely low level of HMF and Furfural present. The amount of HMF and Furfural present are below 1 ppm.

### Example 11: Measuring the Weight-Average Molecular Weight of the Cargill Resistant Dextrin 1

The following non-limiting example describes how the weight-average molecular weight of the Cargill resistant dextrin 1 was measured by chromatography. The column used in the chromatography was a Shodex S-K804+Shodex KS-802 (all sodium form) in series operating at 75° C., and a pre-column Bio-Rad de-ashing system was used. The column was calibrated using a set of sugars and pullulans of known molecular weight. For each calibration, the logarithm of the molecular weight was plotted against the retention time.

The Cargill resistant dextrin 1 was dissolved in HPLC grade water solution at approximately 10 weight % dry substance, and then filtered through a 0.45 μm disposable filter. The samples were then analyzed by an Agilent HPLC system.

The solution containing the Cargill resistant dextrin 1 was then injected into the column, 20 μl was injected. The solution passed through the column at a flow rate of 0.8 ml/min.

A differential refractive index was used to detect the weight-average molecular weight of the Cargill resistant dextrin 1. The data was processed with a Caliber device (GPC package from polymer labs).

After completion of each run, the data processing device fitted a baseline to the chromatogram, and then cut the area comprised between the baseline and the chromatogram into a large number of small slices. The area of each slice was recorded, and the molecular weight corresponding to each slice derived from the calibration curve. Using these values, the data processing device calculated the weight-average molecular weight. The result is displayed in Table 11.

To provide a comparison, the weight-average molecular weight of Promitor SGF 70 R, Promitor NGR 85, Fibersol-2 NONGMO, Nutriose FM10 and Nutriose FM6 was also measured in the same way. The same procedure as carried out with the Cargill resistant dextrin 1 was used with these additional samples. The weight-average molecular weight for the samples is displayed in Table 11.

TABLE 11
The weight-average molecular weight for the samples.

| | Weight average |
|---|---|
| | molecular |
| | weight |
| Sample | (g/mol) |
| Cargill resistant dextrin 1 | 1250-1750 |
| Promitor SGF 70 R | 1250-1750 |
| Promitor NGR 85 | 1750-2250 |
| Fibersol-2 NONGMO | 2750-3250 |
| Nutriose FM10 | 2500-3000 |
| Nutriose FM6 | 3750-4250 |

As shown in Table 11, the Cargill resistant dextrin 1 has a similar weight-average molecular weight when compared to Promitor SGF 70 R, and a low weight-average molecular weight compared to other fibers.

### Example 12: Measuring the Morphology of the Cargill Resistant Dextrin 1

The following non-limiting example describes how the morphology of the Cargill resistant dextrin was measured.

In this non limiting example, the Cargill resistant dextrin 1 was placed into a scanning-electron microscope (SEM: TM4000Plus Tabletop Microscope from Hitachi). Images were obtained by raster-scanning a focused electron beam over the sample and detecting any secondary electrons emitted, or any electrons backscattered by the sample. The voltage used was 15 KVolts, and sample analysis was made without any pre-coating.

To provide a comparison, images of Promitor SGF 70 R, Promitor NGR 85, Fibersol-2 NONGMO, Nutriose FM10 and Nutriose FM6 were also obtained. The same procedure as carried out with the Cargill resistant dextrin 1 was used with these additional samples. The voltage used was 15 KVolts, and sample analysis was made without any pre-coating.

The Cargill resistant dextrin 1 advantageously has a spherical, or almost spherical, morphology.

### Example 13: Determining the Moisture Content of the Cargill Resistant Dextrin 1 in Powder (Particulate) Form

The following non-limiting example describes how the moisture content of the Cargill resistant dextrin was determined.

In this non-limiting example, the moisture content of the Cargill resistant dextrin 1 was measured by thermogravimetric analysis (TGA) with a Mettler-Toledo (TGA/DSC 3+). The device was automatically calibrated prior to the measurements (linearity at three points, without external manipulation).

The Cargill resistant dextrin 1 was then weighed into a 100 μL aluminum crucible from Mettler-Toledo, 30 mg of the Cargill resistant dextrin was measured out into the crucible. The temperature of the thermogravimetric analysis device was set at 25° C. to 240° C. using a heating rate of 10° C./min. The flow of nitrogen in the thermogravimetric analysis device was set at 50 ml/min.

The crucible containing the Cargill resistant dextrin was placed into the thermogravimetric analysis device and the moisture content determined using Star software. The result is shown in Table 12.

To provide a comparison, the moisture content of Promitor SGF 70 R, Promitor NGR 85, Fibersol-2 NONGMO, Nutriose FM10, Nutriose FM6 and Frutafit® HD was also measured in the same way. The same procedure as carried out with the Cargill resistant dextrin 1 was used with these additional samples. The moisture content for the samples is displayed in Table 12.

TABLE 12
The moisture content of the samples.

| | Moisture |
|---|---|
| | content |
| Sample | (weight %) |
| Cargill resistant dextrin 1 | 4.0-4.5 |
| Promitor SGF 70 R | 3.5-4.0 |
| Promitor NGR 85 | 33.5-4.0 |
| Fibersol-2 NONGMO | 4-5 |
| Nutriose FM10 | 5.0 |
| Nutriose FM6 | 6.0-6.5 |
| Frutafit ® HD | 3.0-3.5 |

### Example 14: Making Food Products Comprising the Cargill Resistant Dextrin 1

The following non-limiting example describes how food products comprising the Cargill resistant dextrin 1 were made.

Table 13 sets out the weight % of each component present in refined and unrefined fillings that comprise the Cargill resistant dextrin 1, as well as Promitor SGF 70 R, Promitor NGR 85, Fibersol-2 NONGMO and Frutafit® HD. The refined and unrefined fillings that comprises the Cargill resistant dextrin 1 are called unrefined/refined product A, the refined and unrefined fillings that comprise Promitor SGF 70 R are called unrefined/refined product B, the refined and unrefined fillings that comprise Promitor NGR 85 are called unrefined/refined product C, the refined and unrefined fillings that comprise Fibersol-2 NONGMO are called unrefined/refined product D and the refined and unrefined fillings that comprise Frutafit® HD are called unrefined/refined product E.

TABLE 13
The composition of the refined/unrefined products A, B, C, D and E.

| | Unrefined/ | Unrefined/ | Unrefined/ | Unrefined/ | Unrefined/ |
|---|---|---|---|---|---|
| | refined | refined | refined | refined | refined |
| Raw material used | product A | product B | product C | product D | product E |
| Icing Sugar S0, Sudzücker | 23.2 | 22.95 | 24.45 | 24.35 | 23.2 |
| Cocoa powder, Gerkens ™ 10-12% | 8 | 8 | 8 | 8 | 8 |
| GT78 | | | | | |
| Palm Coconut Blend Cremoflex © | 34 | 34 | 34 | 34 | 34 |
| F3303 | | | | | |
| Skimmed milk powder | 12 | 12 | 12 | 12 | 12 |
| (Infant grade) Armor proteines | | | | | |
| Fluid Lecithin, Leciprime ™ 1400 | 0.3 | 0.3 | 0.3 | 0.3 | 0.3 |
| IPM | | | | | |
| Natural Vanilla Flavour W1075P, | 0.1 | 0.1 | 0.1 | 0.1 | 0.1 |
| Prova | | | | | |
| Dextrin SweetWise ™ soluble fiber | 22.4 | | | | |
| DC (Cargill resistant dextrin 1) | | | | | |
| Promitor SGF 70 R | | 22.65 | | | |
| Promitor NGR 85 | | | 21.15 | | |
| Fibersol-2 NONGMO | | | | 21.25 | |
| Frutafit ® HD | | | | | 22.4 |

The method of making an unrefined filing required any fats and mixing bowls to be placed in the oven (oven used is a Memmert, UF110) the day before making the unrefined filling. The mixing bowls and fats were heated at a temperature of 45° C. Then, on the day of preparing the unrefined filling all powders were weighed and blended in a plastic bag. The powder was added to the now hot mixing bowl, and 25 weight % of the fat was added and the mixture blended manually to avoid powder loss. The mixture was then mixed automatically for 5 minutes. The mixture was scraped, and mixed again automatically for 5 minutes. Any remaining fat and the lecithin was added. The mixture was then mixed manually and then automatically for 5 minutes. The mixture was scraped and mixed for 10 minutes. The bowl comprising the mixture was then placed in the oven at a temperature of 45° C. for at least an hour and for at most 24 hours. The bowl was then taken out of the oven, and the mixture transferred to a plastic beaker. Approximately 23 smaller bowls or cups were laid out and filled with 50 g of the mixture. The bowls or cups containing the mixture were transferred to a fridge at a temperature of 4° C. and left to cool for 20 minutes. The bowls or cups were taken out of the fridge, and a lid placed on the bowls or cups after 10 minutes. The unrefined filling was then stored in conditioned conditions of 20° C. and a relative humidity of 40% moisture.

The method of making a refined filing required any fats and mixing bowls to be heated the day before making the refined fillings. The mixing bowls were electrically heated to a temperature of 45° C. Then on the day of preparing the refined fillings, all powders were weighed and blended in a plastic bag. The powder was added to the now hot mixing bowl, and 22 weight % of the fat was added and the mixture blended manually. The mixture was then mixed automatically for 10 minutes. The mixture was scraped, and mixed again automatically for 5 minutes. The mixture was refined to a particle size of 25 μm by using a 3 roll refiner (Buhler SDY 200). The refined flakes were then transferred back to the hot bowl. Any remaining fat and the lecithin were added. The mixture was then mixed manually and then automatically for 10 minutes. The mixture was scraped and mixed for 10 minutes. The mixture was transferred to a bucket, and then placed in an oven at a temperature of 45° C. for at least an hour and for at most 24 hours. The bucket and mixture were then taken out of the oven, and the mixture was transferred to a plastic beaker. Approximately 23 smaller bowls or cups were laid out and filled with 50 g of the mixture. The bowls or cups containing the mixture were transferred to a fridge at a temperature of 4° C. and left to cool for 20 minutes. The bowls or cups were taken out of the fridge, and a lid placed on the bowls or cups after 10 minutes. The refined filling was then stored in conditioned conditions of 20° C. and a relative humidity of 40% moisture.

Table 14 sets out the weight % of each component present in the chocolate made comprising the Cargill resistant dextrin 1, as well as Promitor SGF 70 R, Promitor NGR 85, Fibersol-2 NONGMO and Frutafit® HD. The chocolate product comprising the Cargill resistant dextrin 1 is called Chocolate A, the chocolate product comprising Promitor SGF 70 R is called Chocolate B, the chocolate product comprising Promitor NGR 85 is called Chocolate C, the chocolate product comprising Fibersol-2 NONGMO is called Chocolate D and the chocolate product comprising Frutafit® HD is called Chocolate E.

TABLE 14
The composition of chocolate A, B, C, D and E.

| | Chocolate | Chocolate | Chocolate | Chocolate | Chocolate |
|---|---|---|---|---|---|
| Raw material used | A | B | C | D | E |
| Icing Sugar SO, Sudzücker | 20.1 | 19.85 | 21.3 | 21.2 | 20.1 |
| Cocoa liquor WAF 04 | 10.7 | 10.7 | 10.7 | 10.7 | 10.7 |
| Cocoa butter PPP00; Full Deo | 24.5 | 24.5 | 24.5 | 24.5 | 24.5 |
| Whole milk powder 26% | 22.6 | 22.6 | 22.6 | 22.6 | 22.6 |
| Fluid Lecithin, Leciprime ™ 1400 IPM | 0.5 | 0.5 | 0.5 | 0.5 | 0.5 |
| Natural Vanilla Flavour W1075P, Prova | 0.1 | 0.1 | 0.1 | 0.1 | 0.1 |
| Cargill resistant dextrin 1 | 21.5 | | | | |
| Promitor SGF 70 R | | 21.75 | | | |
| Promitor NGR 85 | | | 20.3 | | |
| Fibersol-2 NONGMO | | | | 20.4 | |
| Frutafit ® HD | | | | | 21.5 |

The method of making chocolate required the cocoa butter and cocoa liquor to be heated, along with the mixing bowls. The cocoa butter, cocoa liquor and mixing bowls were electrically heated. Then all the powders were weighed, put together and blended (in a plastic bag). The powders were then transferred into the hot mixing bowl and all of the cocoa liquid and 10 to 14 weight % of the cocoa butter added. The mixture was blended manually to mix the fat and powder, and then mixed automatically for 10 minutes. The mixture was then scraped, and then mixed for a further 5 minutes. The particle size of the mixture was then refined to a particle size of 25 μm using a 3 roll refiner (Buhler, SDY 200). The refined mixture was then transferred to hot conching (Buhler ELK 0005-V) equipment (at a temperature of 60° C.) and exposed to a dry conching step for 5.5 hours. Then, any remaining fat and lecithin was added. The mixture was then exposed to a further wet conching step for 0.5 hours.

### Example 15: Measuring the Hardness of the Unrefined and Refined Fillings A. C. D and a Reference Product

The following non-limiting example describes how the hardness of unrefined and refined products was measured.

In this non-limiting example, a texture analyzer (StableMicroSystems, TA.XTplus C) was used to determine the force needed to break, compress or penetrate the unrefined and refined products. The hardness of a fat based filling can be measured using a texture analyzer with a cylinder probe. The texture analyzer includes an arm, which pushes the cylinder probe downwards at a certain speed for a certain distance, measuring the resistance of the sample (which is an opposite force to the downward force). This resistance is recorded. Harder samples give higher resistance to the penetrating cylinder, which results in a bigger force on the load cell. The load cell detects how much “force” or “resistance” is applied. The load cell basically acts as a “balance” measuring the “weight” of the resistance of the sample. Cylinders are present in different sizes and materials, and the selection depends on the size of the container (in which the filling to be measured is stored). The cylinder diameter must be 3 times smaller than the diameter of the container. This is to avoid “wall effects” which influences results. The material type of the cylinder depends on the samples to be measured. but for fat based fillings. both delrin & aluminum probes can be used. It is very important to always use the same cylinder & container throughout a series. Comparison between trials can only be made if the cylinder. container and equipment settings are kept the same throughout the whole test. Storage and measuring temperatures were maintained at a temperature of 20° C. and a relative humidity of 40 weight % moisture, because the hardness of a fat-based product can change with temperature.

In this non-limiting example, the unrefined product A was melted in an oven overnight at a temperature of 45° C. The melted unrefined product A was stirred until homogeneous. The unrefined product A was poured into containers in equal amounts and then placed in a fridge at a temperature of 4° C. for 30 minutes. The unrefined product A was then removed, and stored at a temperature of 20° C. for 24 hours. The unrefined product A was then placed onto the texture analyzer, and the moving arm of the analyzer was lowered until the probe was just above the sample (without actually touching the sample). The unrefined product A was then placed onto the texture analyzer, and the moving arm of the analyzer was lowered until the probe was just above the unrefined product A (without actually touching the unrefined product A). The unrefined product A was immobilized. The texture analyzer then measured the hardness of the unrefined product A. The probe moved down at a speed of 0.5 mm/s and penetrated the top 10 mm of the surface of the product. The measurement was repeated 5-10 times, and the average hardness measurement determined. The measurement was repeated on day one, fourteen, thirty, sixty and ninety after making the unrefined product A. and the results are the range of hardness values measured over the period of time. The same procedure was carried out for refined products C and D. The results are shown in Table 15.

To provide a comparison, the hardness of refined products A. C and D was measured. The same procedure as carried out with the unrefined product A was used. The results are shown in Table 15.

To provide a further comparison, the hardness of a full-sugar reference product for refined and unrefined products not containing any substitute fibers was measured. The full-sugar reference product contains sugar instead of the resistant dextrin as outlined in Table 13, with the other ingredients the same: the reference product therefore contains 45.6 weight % sugar. The same procedure as carried out with the unrefined and refined products was used. The hardness of the refined and unrefined filings is displayed in Table 15.

TABLE 15
The hardness of refined and unrefined products A, C and D, and
a full-sugar reference product. The results are the range of
hardness values measured one, fourteen, thirty, sixty and ninety
days after making the products.

| | | Hardness |
|---|---|---|
| Product Type | Product/Product including | (Force in g) |
| Unrefined | Full-sugar reference product | 2000-3000 |
| | Unrefined product A | 2000-3100 |
| | Unrefined product C | 4000+ |
| | Unrefined product D | 4000+ |
| Refined | Full-sugar reference product | 9000-23000 |
| | Refined product A | 9000-20000 |
| | Refined product C | 9000-20000 |
| | Refined product D | 9000-17000 |

As can be seen from Table 15, the Cargill resistant dextrin 1 (unrefined and refined products A) creates a final product having similar hardness to the full-sugar reference product.

### Example 16: Measuring the Hardness of Chocolate Products a, B, C, D and a Reference Product

The following non-limiting example describes how the hardness of chocolate products A, B, C, D and a full-sugar reference product was measured.

In this non-limiting example, a texture analyzer (StableMicroSystems, TA.XT plus C) was used to determine the force needed to break, compress or penetrate the products. Hardness of a chocolate tablet can be measured using a texture analyzer with a needle-like penetration probe. The arm of the texture analyzer pushes the probe downwards at a certain speed for a certain distance, measuring the resistance of the product (which is an opposite force to the downward force). This resistance can be recorded in a graph of force versus time. Harder products give higher resistance to the penetrating needle, which results in a bigger force on the load cell. The load cell detects how much “force” or “resistance” is applied: the load cell basically acts as a “balance” measuring the “weight” of the resistance of the product. The maximum penetration force is calculated and used to calculate the hardness of the product. The area under the graph (of force versus time) can be calculated, and corresponds with the work of penetration. The storage and measuring temperatures are controlled, because the hardness of the product can change with time.

In this non-limiting example, chocolate A was prepared by melting 450 g of the product in an oven overnight at a temperature of 45° C. A double-jacketed water bath was then pre-heated to a temperature of from 33.0 to 33.2° C. The melted chocolate was homogenized with a spoon, and then 198.0 g of the melted chocolate was transferred to the double-jacketed water bath. Then, 2 g of cocoa butter crystal seeds (Mycryo, Barry Callebaut) were weighed separately. Then a double-fin stirrer was lowered to the bottom of the filled double-jacketed water bath and the process of pre-crystallization begun. Pre-crystallization is achieved by starting the stirrer at a rpm of 51 and timer simultaneously (time zero is the time at which the timer is started), after 10 minutes and 30 seconds from time zero, the cocoa butter crystal seeds are added within 30 seconds. Then after 16 minutes 30 seconds from time zero, the mixing speed was increased to 158 rpm. Then after 18 minutes 30 seconds from time zero, the stirrer was stopped. The chocolate can then be poured into a chocolate mould, and any excess chocolate scrapped off with a T shaped spatula. The chocolate mould was a magnetic mould having a disk shape. A piece of baking paper was placed between the sample and a magnetic mould. The mould was placed in the fridge at a temperature of 4-5° C. for 30 minutes. Then the chocolate was removed from the magnetic mould and stored at 20° C. in a closed container. A piece of baking paper was placed between the sample and a magnetic mould. The mould was placed in the fridge at a temperature of 4-5° C. for 30 minutes. Then, the chocolate was removed from the magnetic mould and stored at 20° C. in a closed container. The chocolate was then placed onto the texture analyzer, and the moving arm of the analyzer was lowered until the probe was just above the chocolate (without actually touching the sample). The chocolate was immobilized. The texture analyzer then measured the hardness of the chocolate. The probe moved down at a speed of 0.5 mm/s, and penetrated the top 2 mm of the surface of the chocolate. The measurement was repeated 5-10 times, and the average hardness measurement determined. The results are shown in Table 16.

To provide a comparison, the hardness of chocolate B. C and D was also measured in the same way. The same procedure as carried out with chocolate A was used. The results are shown in Table 16.

To provide a further comparison, the hardness of a full-sugar reference product not containing any substitute fibers was measured. The full-sugar reference product contains sugar instead of the resistant dextrin as outlined in Table 14, with the other ingredients the same: the reference product therefore contains 41.6 weight % sugar. The same procedure as carried out with chocolate A was used. The results are shown in Table 16.

TABLE 16
The hardness of a chocolate product comprising the
Cargill resistant dextrin 1 and chocolate products
comprising alternative fibers, one day after making
the chocolate products.

| | Hardness |
|---|---|
| Product | (Force in g) |
| Full-sugar reference product | 3500-4500 |
| Chocolate A | 3500-4500 |
| Chocolate B | 3000-4500 |
| Chocolate C | 3500-4500 |
| Chocolate D | 3500-4500 |

As can be seen from Table 16, the Cargill resistant dextrin 1 (in chocolate A) creates a final product having similar hardness to the full-sugar reference product.

### Example 17: Measuring the Rheology of Refined Fillings, Unrefined Fillings and Chocolate Products

The following non-limiting example describes how the shear viscosity of food products comprising the Cargill resistant dextrin (or other fibers) was measured using a rheometer (Anton paar MCR 72, with a cup and cylinder geometry) device. The cylinder used was a CC27, the cup was temperature controlled at 40° C. using an air cooling/heating system. The equipment was preheated to 40° C. prior to use.

Prior to use, the device was calibrated using a Thermostabilization cell E.V.A 100 MS-Din or Thermostabilization cell CT MS-DIN with water bath and pump working to get the calibration oil to a temperature of 40.0° C.

Unrefined filling A was liquefied an oven operating at 45-° C. for a minimum of 12 hours. This step ensured that all fat was in the liquefied state. The unrefined filing A was then homogenized by stirring and then 15 to 20 g was added in the cup of the rheometer. Unrefined filling A was then equilibrated at 40° C. in the equipment. Then the unrefined filling A was pre-sheared for 500 s at 5 s⁻¹ to homogenize and control the temperature of the sample. No measuring points were recorded in this interval. Then the unrefined filling A was subjected to a shear rate ramp of 2 s⁻¹ to 50 s⁻¹ with 18 points in 180 seconds. Then the unrefined filling A was subjected to constant shearing at 50 s⁻¹ for 60 seconds. Then the unrefined filling A was subjected to a shear rate ramp of 50 s⁻¹ to 2 s⁻¹ for 180 seconds. During the final shear step, the unrefined filling A was analyzed using Rheocompass software according to IOCCC2000 standard protocol and calculated using the Casson model. The shear viscosity of the unrefined filling A is displayed in Table 15. The same procedure was carried out on refined filling A and chocolate A.

To provide a comparison, the shear viscosity of unrefined fillings B, C, D and E, refined fillings A, B, and E as well as chocolate A, B, C and D was measured in the same way. The same procedure as carried out with the unrefined filling A was used. The shear viscosity of the products is displayed in Table 17.

To provide a further comparison, the shear viscosity of a full-sugar reference product not containing any substitute fibers was measured. The full-sugar reference product contains sugar instead of the resistant dextrin as outlined in Table 13, with the other ingredients the same: the reference product therefore contains 45.6 weight % sugar. The same procedure as carried out with the unrefined filling A was used. The shear viscosity of the full-sugar reference product is displayed in Table 17.

TABLE 17
The shear viscosity of refined filings A, B, C, E and D,
unrefined fillings A, B, and E, and, chocolate A, B, C
and D as well as full-sugar reference products.

| | | Shear |
|---|---|---|
| | | viscosity |
| Type of product | Product/Product including | (Pa · s) |
| Unrefined product | Full-sugar reference product | 1.05 |
| | Unrefined filling A | 1.41 |
| | Unrefined filling B | 0.95 |
| | Unrefined filling C | 1.60 |
| | Unrefined filling E | 1.53 |
| | Unrefined filling D | 1.80 |
| Refined product | Full sugar reference product | 0.98 |
| | Refined filling A | 1.17 |
| | Refined filling B | 1.36 |
| | Refined filling E | 1.21 |
| Chocolate product | Full sugar reference product | 0.95 |
| | Chocolate A | 0.97 |
| | Chocolate B | 0.61 |
| | Chocolate C | 0.97 |
| | Chocolate D | 1.13 |

As can be seen from Table 17, the Cargill resistant dextrin 1 creates a final product having similar shear viscosity to the full-sugar reference product.

### Example 18: Sensory Tests Conducted on Unrefined Fillings

The following non-limiting example sets out data obtained by a panel of trained tasters tasting the unrefined filling A. The panel of trained tasters were trained to analyze certain attributions of the unrefined filling A.

In this example, the sampling of unrefined filling A was repeated three times, and the number of tasters on the panel varied from 9 (first assessment), 11 (second assessment) and 10 (third assessment). Each time, the panel was served 15 g of the unrefined filling A at room temperature with. The unrefined filling A was described as a three-digit code in each serving. The panelists were allowed to swallow the unrefined filling A. The panelists were given five minutes between trying each unrefined filling A before trying the next. The panel used Table 18 to evaluate the unrefined filling A.

TABLE 18
A table setting out the descriptive terms used to evaluate the unrefined filling A.

| Appearance | | Low | High |
|---|---|---|---|
| Color | The intensity of the color at the surface | Light brown | Dark brown |
| | of the sample | | |

Taste

| | | | |
|---|---|---|---|
| Sweet | Basic taste associated with sugar or | Not sweet | Very sweet |
| | sweeteners | | |
| Sour | Basic taste associated with acids | Not sour | Very sour |
| | (citric acid, malic acid, lactic acid) | | |
| Bitter | Basic taste associated with caffeine, | Not bitter | Very bitter |
| | hop, quinine | | |
| Cacao | A usually bitter pungent taste associated | No cacao | A lot of cacao |
| | with cacaobean, cacaopowder. | | |
| | Sometimes a dry chalk taste. | | |
| Chocolate | A balanced round taste of chocolate as | No chocolate | A lot of |
| | in chocolate products. | | chocolate |
| Alkali | The complex taste is flattened. | Not alkali | Very alkali |
| | Associated with a less sweet, less sour, | | |
| | less roasted taste. | | |
| Roasted | Taste associated with a moderate heated | Not roasted | Very roasted |
| | foodstuff. Associated with roasted | | |
| | cacao beans or coffee. | | |
| Caramel | Taste associated with heated sugar with | No caramel | A lot of caramel |
| | a creamy to light brown discoloration. | | |
| Nutty | Taste associated with non-roasted notes, | Not nutty | Very nutty |
| | especially almonds and hazelnuts (as in | | |
| | Nutella) | | |

As a result of the taste analysis, it was determined that the unrefined filling A was dark brown in color, had a low bitter taste, had a low sour taste, was very sweet and had a high cacao and chocolate flavor and a low caramel flavor.

### Example 19: Of Producing a Resistant Dextrin (in Liquid Form)

A resistant dextrin (in liquid form) according to the present invention was prepared. The resistant dextrin (in liquid form) produced is referred to as “Cargill resistant dextrin in liquid form 1” in the present examples.

In this non-limiting example, the following steps were followed to prepare the “Cargill resistant dextrin in liquid form 1”:
(a) providing a saccharide feed comprising at least 55 weight % on a dry solid basis of dextrose and dextrose oligomers;
(b) heating the saccharide feed to a temperature of at least 60° C.;
(c) adding an acidifying catalyst to form an acidic composition;
(d) heating the acidic composition up to at least 190° C.;
(e) injecting the acidic composition through a first microdevice to react the dextrose and/or dextrose oligomers with the acid catalyst in the presence of water for a time sufficient to produce a first reacted composition wherein at least 85 weight % of the dextrose and/or dextrose oligomers have reacted, and wherein the first reacted composition comprises at least 60% weight dry solids;
(f) extracting the water from the first reacted composition to obtain a water-depleted composition comprising at least 98 weight % dry solids;
(g) injecting the water-depleted composition through a second microdevice to react any non-reacted dextrose and/or dextrose oligomers with the acid catalyst at a temperature of at least 220° C. for a time sufficient to produce a second reacted composition wherein at least 92 weight % of the dextrose and/or dextrose oligomer have reacted, and wherein the second reacted composition comprises at least 70 weight % dry solids; and
(h) refining the second reacted composition to form the Cargill resistant dextrin in liquid form 1.

### Example 20: Making Food Products Comprising Cargill Resistant Dextrin in Liquid Form 1-Ice Cream

The following non-limiting example describes how food products comprising the Cargill resistant dextrin in liquid form 1 were made.

Table 19 sets out the weight % of each component present in an ice cream that comprises the Cargill resistant dextrin in liquid form 1, as well as ice creams that comprise Promitor SGF 70 L and Nutriose FM10. The ice cream that comprises the Cargill resistant dextrin in liquid form 1 is called ice cream A, the ice cream that comprise Promitor SGF 70 L is called ice cream B and the ice cream that comprises Nutriose FM10 is called ice cream C.

Ice cream D is a reference ice cream, wherein none of the sugar in the ice cream is replaced with an alternative ingredient. Ice cream D is the reference ice cream.

In ice creams A, B and C, 65% of the total sugar (all of crystalline sugar (called S2 Tiense suiker) & part of glucose-fructose syrup) was replaced with one of Cargill resistant dextrin in liquid form 1, Promitor SGF 70 L or Nutriose FM10.

The weight % of each component in each of the ice creams A, B, C and D is shown in Table 19 and was calculated to equal dry substance.

TABLE 19
The composition in weight % of ice creams A, B, C and D.

| | | | | Ice |
|---|---|---|---|---|
| | Ice | Ice | Ice | cream |
| | cream | cream | cream | D |
| Raw material used | A | B | C | (reference) |
| Tap water | 58.37 | 58.97 | 62.87 | 62.40 |
| Refined coconut oil CN25 | 6 | 6 | 6 | 6 |
| Skimmed milk powder (Infant grade) | 5.50 | 5.50 | 5.50 | 5.50 |
| Armor proteines | | | | |
| Whey protein concentrate WPC30 | 4.50 | 4.50 | 4.50 | 4.50 |
| Sugar (S2 Tiense suiker) | | | | 9 |
| Glucose-fructose syrup C*Sweet F 017Y4 | 9 | 9 | 9 | 12 |
| Cargill resistant dextrin in liquid form 1 | 16 | | | |
| Promitor SGF 70 L (liquid)* | | 15.40 | | |
| Nutriose FM10 (powder) | | | 11.50 | |
| Lygomme FM3670 | 0.60 | 0.60 | 0.60 | 0.60 |
| Aspartame | 0.018 | 0.018 | 0.018 | |
| Acesulfame K | 0.012 | 0.012 | 0.012 | |

*Promitor SGF 70 L is Promitor SGF 70 R in liquid form.

The method of making an ice cream requires any fats to be placed in an oven (the oven used is a Memmert, FED 720) the day before making the ice cream. The fat was heated to a temperature of 65° C. Then, on the day of preparing the ice cream, all powders were weighed and blended in a plastic bag. The tap water was heated to a temperature of 70° C. and was added into a 25 liter bucket. The blended powders were added into the water and mixed using a typhoon high shear mixer for 1 minute at 1500 rpm to form a liquid mix. The glucose-fructose syrup and the fiber (if liquid as in the case with Cargill resistant dextrin in liquid form 1 and Promitor SGF 70 L—Nitriose FM10 (powder) is added with the powders) were added into the liquid mix and mixed for 1 minute at 1500 rpm. Then, the fat (in the form of molten fat from being in the oven) was added to the liquid mix and blended under high shear using a typhoon high shear mixer for 10 minutes at 1500 rpm. The now homogenous mixture was subjected to a heat treatment, homogenization & cooling using a GEA TDS 00A1847. The heat treatment was done at 86° C. for 30 seconds, followed by a homogenization at 180+30 bars and subsequent cooling at 10° C. The mixture was then collected in sterilized 25 liter buckets which were then closed with a lid. The buckets were transferred to a fridge at 5° C. and subjected to an aging treatment for 18 hours. The mixture was frozen and aerated the next day using a Tetra Hoyer KF 80 continuous freezer. The mixture was frozen to −6° C. and aerated with a target of 100% overrun. The now frozen ice cream was filled aseptically in plastic pots of 1000 ml and 250 ml and then quickly cooled in a Koma KCF-15 blast freezer at −40° C. for 4 hours to harden & complete crystallization. After 4 hours, the plastic pots were transferred to a final storage stage which occurs in a freezer at −18° C.

### Example 21: Measuring the Melting Profile of Ice Cream Products A. B C & D

The following non-limiting example describes how the melting profile of ice cream A, B, C and D was measured.

In this non-limiting example, four balances (Mettler Toledo New Classic MF ML2001) alongside the Mettler Toledo easy service/application controller software were used to simultaneously determine the melting speed of ice creams A, B, C and D at room temperature (20° C.). Before the test, O shaped holders were attached to a metal rod above each of the four balances. On these holders, metal grids were installed to allow the ice cream in molten form to run through. Plastic containers were placed on top of each balance to collect the molten ice cream and to allow the amount of molten ice cream reaching the balance to be weighed and registered by the software.

In this non-limiting example, each ice cream product was separately placed in a 250 ml pot and then placed in a freezer overnight at a temperature of −20° C. Each ice cream was then separately removed from the freezer and the weight of each plastic pot and the ice cream separately noted. Each plastic pot was then removed by using a knife to remove the bottom of the plastic pot and then along the side of the plastic pot so as to demold each ice cream separately onto the grid. The weight of the empty plastic pot was measured so that the weight of ice cream could be adjusted (for example, the plastic pot plus ice cream minus the weight of the plastic pot equals the absolute weight of the ice cream). This was repeated for each ice cream A, B, C and D as quickly as possible. After all the ice creams were put on their subsequent grids, the procedure was started through the software. Every 10 seconds, the software registered the weight from the balances and the value was stored. The procedure was completed when all of the ice cream had melted or after 180 minutes (which ever was quickest).

The measurements of time versus weight for each ice cream is shown in Table 20.

TABLE 20
The results as a function of time versus weight
for ice creams A, B, C and D.

| | Ice | Ice | Ice | Ice |
|---|---|---|---|---|
| | cream | cream | cream | cream |
| Time | A | B | C | D |
| Time (min) | 26 | 26 | 27 | 27 |
| for melting | | | | |
| 10 g | | | | |
| Time (min) | 35 | 37 | 41 | 38 |
| for melting | | | | |
| 30 g | | | | |
| Time (min) | 51 | 59 | 61 | 55 |
| for melting | | | | |
| 60 g | | | | |
| Time (min) | 67 | 75 | 75 | 70 |
| for melting | | | | |
| 90 g | | | | |
| Time (min) | 81 | 91 | 86 | 84 |
| for melting | | | | |
| 120 g | | | | |
| Time (min) | 95 | 106 | 103 | 99 |
| for melting | | | | |
| 150 g | | | | |
| Time (min) | 114 | 129 | 123 | 116 |
| for melting | | | | |
| 180 g | | | | |

### Example 22: Measuring the Color of an Ice Cream Product Pre-Mix

The following non-limiting example describes how the color of food products comprising the Cargill resistant dextrin in liquid form 1 (or the other fibers) was measured using a colorimeter (Konica Minolta CM-5 spectrophotometer) device.

In this non-limiting device, the CIELAB color space (also known as CIE L*A*B*) was used as a model to determine the color of each ice cream as a pre-mix. The colorimeter on which the CIELAB color space was measured was calibrated using a CM-A124 Zero Calibration Box, prior to use.

To form ice cream pre-mixes, each of ice cream A, B, C and D were matured for 18 hours at 5° C. to form a pre-mix. Ice cream A formed ice cream pre-mix A, ice cream B formed ice cream pre-mix B, ice-cream C formed ice cream pre-mix C and ice cream D formed ice cream pre-mix D. Once the pre-mixes were formed, separate petri dishes were filled up to three quarters of the height of the petri dish with different ice cream pre-mixes. The petri dishes were individually placed on top of the colorimeter. The color of the ice cream pre-mix was then measured in triplicate and the average result automatically calculated by the colorimeter. The parameters used for this measurement are outlined in Table 21. The procedure was repeated for each ice cream A, B, C and D. The results are shown in Table 22.

TABLE 21
Parameter settings for standard color measurements.

| Auto | |
|---|---|
| measurement | 3 times (triplicate) |
| Color Space | L* a* b* ΔE 00 |
| Color Index | None |
| Observer | 10 degrees |
| Illuminant 1 | D65 |
| Illuminant 2 | None |
| Measurement type | Petri Dish |
| Meas. Area | 30 mm |
| SCI/SCE* | SCE (Excluded) |
| Calibration tools | cylindric black tube |

*wherein SCI is the Specular Component Included and SCE is the Specular Component Excluded.

TABLE 22
The color of ice cream pre-mixes A, B, C and D.

| | Ice cream | Ice cream | Ice cream | Ice cream |
|---|---|---|---|---|
| | pre-mix | pre-mix | pre-mix | pre-mix |
| | A | B | C | D |
| L | 88.74 | 87.76 | 88.76 | 89.01 |
| A | −1.98 | −1.51 | −2.11 | −2.15 |
| B | 14.7 | 15.88 | 16.08 | 14.25 |
| Delta | 0.41 | 1.54 | 1.12 | |
| E* | | | | |

*wherein Delta E is the average difference between the reference sample (ice cream pre mix D) and each of ice cream pre-mixes A, B and C.

Advantageously, ice cream pre-mix A (which comprises Cargill resistant dextrin in liquid form 1) has a delta E value of below 1.

### Example 23: Making Food Products Comprising the Cargill Resistant Dextrin in Liquid Form 1-Ketchup

The following non-limiting example describes how food products comprising the Cargill resistant dextrin in liquid form 1 were made.

Table 23 sets out the weight % of each component present in ketchup that comprises the Cargill resistant dextrin in liquid form 1. The ketchup that is 50% sugar reduced and comprises the Cargill resistant dextrin in liquid form 1 is called ketchup B, the ketchup that is 25% sugar reduced and comprises the Cargill resistant dextrin in liquid form 1 is called ketchup C, and the ketchup that is 15% sugar reduced and comprises the Cargill resistant dextrin in liquid form 1 is called ketchup D.

Ketchup A is a reference ketchup, wherein none of the sugar is replaced with an alternative ingredient. Ketchup A contains 18 weight % sugar Ketchup A is the reference ketchup.

The weight % of each component in each of the ketchups A, B, C and D is shown in Table 23.

TABLE 23
The composition in weight % of ketchups A, B, C and D.

| | Ketchup | Ketchup | Ketchup | Ketchup |
|---|---|---|---|---|
| Raw material used | A | B | C | D |
| Tomato concentrate (28%) (Elvea) | 30 | 30 | 30 | 30 |
| Sugar (Tirlemont-S2) | 18 | 9 | 13.5 | 15.3 |
| Vinegar (7%) (Colruyt-everyday) | 5 | 5 | 5 | 5 |
| Starch C* Tex 06205 | 2 | 2 | 2 | 2 |
| Cargill resistant dextrin in liquid form 1 | 0 | 12.8 | 6.4 | 3.8 |
| Salt (Colruyt-everyday) | 1.5 | 1.5 | 1.5 | 1.5 |
| Water | 43.5 | 39.7 | 41.6 | 42.4 |

The method of making ketchup required all the dry ingredients to be blended together first. This encompassed weighing the sugar, starch & salt in a plastic bag and mixing by manually shaking until the dry ingredients were homogenous. The wet ingredients were weighed and dosed directly in the IKA reactor (IKA® LR 1000 basic). This encompassed the tomato concentrate, vinegar, water and the Cargill resistant dextrin in liquid form (optionally, depending on the ketchup formed). On top of the wet ingredients, the powder ingredients were added and stirred in the IKA reactor for 2 minutes at 800 rpm. After 2 minutes, when the mixture was homogenized, the IKA reactor was set to 95° C.-130 RPM. When the mixture (ketchup) reached 95° C., the mixture mixed at 130 RPM for 5 more minutes. Once the mixing was complete, the ketchup was formed and was dosed in plastic pots of 100 ml. Once each plastic pot had been filled, the plastic pots containing the ketchup were transferred to an ice bath (at approx. 1-4° C.) for rapid cooling to room temperature (20° C.). After cooling the plastic pots were closed with a lid and stored at 4° C. in a fridge.

### Example 24: Measuring the Viscosity Profile of Ketchup Sauces

The following non-limiting example describes how the shear viscosity of ketchups A, B, C and D was measured.

In this non-limiting example, the shear viscosity of ketchups A, B, C and D was measured using a rheometer device. The device used was Anton paar MCR 51 with a cup and cylinder geometry, wherein the cylinder used was a CC27 and the cup was temperature controlled at 20° C. using an air cooling/heating system. The device was preheated to 20° C. prior to use.

Prior to use, the device was calibrated using a Thermostabilization cell E.V.A 100 MS-Din or Thermostabilization cell CT MS-DIN with water bath and pump working to get the calibration oil to a temperature of 40.0° C.

Each ketchup was separately taken out of the fridge prior to use. Each ketchup was separately added into the cup of the rheometer until the cup was four fifths full. Each ketchup was then separately equilibrated for 1 minute at 20° C. in the equipment. Then each ketchup was separately subjected to a measuring program with increased shear rate. The measuring program subjected each ketchup separately to a logarithmic shear rate ramp of 1 s⁻¹ to 200 s⁻¹ with 40 points in 400 seconds. The viscosity of each ketchup is displayed as a function of shear rate in Table 24.

The same procedure was carried out on all of the ketchups B, C and D.

To provide a further comparison, the shear viscosity of ketchup A was measured. Ketchup A contains sugar instead of Cargill resistant dextrin in liquid form 1 (as shown in Table 23), with the other ingredients the same. The same procedure as carried out with Ketchups B, C and D was carried out on Ketchup A. The viscosity of Ketchup A is displayed as a function of shear rate in Table 24.

TABLE 24
The shear rate versus viscosity for ketchups A, B, C and D.

| Shear rate | Ketchup | Ketchup | Ketchup | Ketchup |
|---|---|---|---|---|
| (s⁻¹) | A | B | C | D |
| 1.001 | 0.4441 | 0.4275 | 0.4148 | 0.3893 |
| 1.146 | 0.48435 | 0.4659 | 0.4732 | 0.42275 |
| 1.312 | 0.52825 | 0.50915 | 0.516 | 0.4603 |
| 1.503 | 0.5776 | 0.5571 | 0.5639 | 0.5026 |
| 1.722 | 0.63325 | 0.6101 | 0.6171 | 0.54895 |
| 1.972 | 0.6942 | 0.66605 | 0.67625 | 0.59955 |
| 2.26 | 0.76075 | 0.731 | 0.74255 | 0.65555 |
| 2.589 | 0.93315 | 0.80225 | 0.8421 | 0.71805 |
| 2.964 | 0.91775 | 0.8798 | 0.8893 | 0.789 |
| 3.396 | 1.00705 | 0.9042 | 0.9781 | 0.8673 |
| 3.892 | 1.112 | 1.0591 | 1.074 | 0.94945 |
| 4.458 | 1.225 | 1.1645 | 1.1835 | 1.0415 |
| 5.105 | 1.3595 | 1.283 | 1.3105 | 1.146 |
| 5.85 | 1.507 | 1.4205 | 1.4555 | 1.26 |
| 6.699 | 1.6665 | 1.564 | 1.613 | 1.4015 |
| 7.674 | 1.859 | 1.7445 | 1.793 | 1.5475 |
| 8.793 | 2.0565 | 1.9325 | 1.9865 | 1.7145 |
| 10.07 | 2.2835 | 2.1625 | 2.209 | 1.9055 |
| 11.54 | 2.5385 | 2.4115 | 2.4575 | 2.109 |
| 13.21 | 2.82 | 2.6775 | 2.7345 | 2.343 |
| 15.14 | 3.134 | 2.9675 | 3.0425 | 2.6105 |
| 17.35 | 3.4375 | 3.3015 | 3.388 | 2.803 |
| 19.86 | 3.8335 | 3.6795 | 3.7645 | 3.236 |
| 22.75 | 4.1965 | 4.086 | 4.184 | 3.5895 |
| 26.07 | 4.6485 | 4.5335 | 4.658 | 3.982 |
| 29.86 | 5.114 | 5.012 | 5.1305 | 4.4055 |
| 34.2 | 5.698 | 5.5605 | 5.779 | 4.8865 |
| 39.18 | 6.261 | 6.1175 | 6.401 | 5.3765 |
| 44.89 | 6.8915 | 6.842 | 7.106 | 6.0115 |
| 51.41 | 7.6845 | 7.572 | 7.9145 | 6.671 |
| 58.9 | 8.442 | 8.3255 | 8.7675 | 7.3845 |
| 67.45 | 9.1785 | 9.2795 | 9.698 | 8.209 |
| 77.27 | 10.1475 | 10.389 | 10.775 | 9.1355 |
| 88.52 | 11.255 | 11.52 | 12.075 | 10.1405 |
| 101.4 | 12.43 | 12.735 | 13.405 | 11.22 |
| 116.1 | 13.665 | 14.095 | 14.81 | 12.435 |
| 133 | 15.06 | 15.75 | 16.4 | 13.84 |
| 152.4 | 16.72 | 17.585 | 18.29 | 15.45 |
| 174.6 | 18.575 | 19.595 | 20.495 | 17.135 |
| 200 | 20.67 | 21.745 | 22.845 | 19.075 |

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

Although certain example aspects of the invention have been described, the scope of the appended claims is not intended to be limited solely to these examples. The claims are to be construed literally, purposively, and/or to encompass equivalents.

1. A resistant dextrin in particulate form, having:
a SPAN of at most 2.7; and
a specific surface area of from 0.05 to 0.20 m²/g, as measured by the Brunauer-Emmett-Teller (BET) adsorption method.

2. The resistant dextrin of claim 1, wherein the SPAN is at most 2.15.

3. The resistant dextrin of claim 1, wherein the specific surface area is from 0.10 to 0.18 m²/g, as measured by the Brunauer-Emmett-Teller (BET) adsorption method.

4. The resistant dextrin according to claim 1, having a dextrose equivalent (DE) of from 5 to 20 weight % on a dry solid basis;
having a 5-hydroxymethylfurfural (HMF) content of at most 5 ppm;
or combinations thereof.

5. The resistant dextrin according to claim 1, having a glass transition temperature (Tg) of 70° C. or below when measured at a moisture content of 5% or above;
having a DP1 and DP2 content, wherein DP1 and DP2 are present at a combined weight % of at most 40 weight %;
or combinations thereof.

6. The resistant dextrin according to claim 1, having:
a D10 in the range of from 1 to 40 μm
a D50 in the range of from 5 to 100 μm
a D90 in the range of from 20 to 200 μm;
or combinations thereof.

7. The resistant dextrin according to claim 1, having a weight-average molecular weight of from 1000 to 2000 g/mol;
wherein the total amount of monosaccharides and disaccharides is at most 25 weight % on a dry solids basis;
or combinations thereof.

8. The resistant dextrin according to claim 1, wherein the resistant dextrin has a substantially spherical morphology;
wherein the resistant dextrin does not comprise sorbitol;
or combinations thereof.

9. (canceled)

10. (canceled)

11. A method for making the resistant dextrin in particulate form according to claim 1, the method comprising:
(a) providing a saccharide feed comprising at least 35 weight % on a dry solid basis of dextrose and/or dextrose oligomers;
(b) heating the saccharide feed to a temperature of at least 60° C.;
(c) adding an acidifying catalyst to form an acidic composition;
(d) heating the acidic composition up to at least 120° C.;
(e) injecting the acidic composition through a first microdevice to react the dextrose and/or dextrose oligomers with the acid catalyst in the presence of water for a time sufficient to produce a first reacted composition wherein at least 60 weight % of the dextrose and/or dextrose oligomers have reacted, and wherein the first reacted composition comprises from 60 to 90 weight % weight dry solids;
(f) extracting the water from the first reacted composition to obtain a water-depleted composition comprising at least 90 weight %;
(g) injecting the water-depleted composition through a second microdevice to react any non-reacted dextrose and/or dextrose oligomers with the acid catalyst at a temperature of at least 160° C. for a time sufficient to produce a second reacted composition wherein at least 90 weight % of the dextrose and/or dextrose oligomer have reacted, and wherein the second reacted composition comprises from 60 to 80 weight % dry solids;
(h) refining the second reacted composition to form a refined second reacted composition; and
(i) drying the refined second reacted composition to produce the resistant dextrin.

12. The method of claim 11, wherein the microdevice contains one or more of micro mixers, micro heat exchangers and/or micro reactors suitable for the polycondensation of carbohydrates;
wherein the method further comprises the step of collecting the second reacted composition in a basic solution by allowing the second reacted composition to fall under gravity from the second microdevice into a container containing a basic solution;
or combinations thereof.

13. The method according to claim 11, wherein the step of drying the refined second reacted composition is performed by spray drying; wherein the step of drying the refined second reacted composition is performed for a sufficient amount of time until the resistant dextrin has at most 13 weight % moisture.

14. A composition comprising:
the resistant dextrin in particulate form according to claim 1; and,
water.

15. The composition of claim 14, wherein the composition comprises the resistant dextrin in particulate form at from 55 to 98 weight %.

16. A method of forming a resistant dextrin in liquid form, the method comprising:
(a) providing a saccharide feed comprising at least 35 weight % on a dry solid basis of dextrose and/or dextrose oligomers;
(b) heating the saccharide feed to a temperature of at least 60° C.;
(c) adding an acidifying catalyst to form an acidic composition;
(d) heating the acidic composition up to at least 120° C.;
(e) injecting the acidic composition through a first microdevice to react the dextrose and/or dextrose oligomers with the acid catalyst in the presence of water for a time sufficient to produce a first reacted composition wherein at least 60 weight % of the dextrose and/or dextrose oligomers have reacted, and wherein the first reacted composition comprises from 60 to 90 weight % weight dry solids;
(f) extracting the water from the first reacted composition to obtain a water-depleted composition comprising at least 90 weight % dry solids;
(g) injecting the water-depleted composition through a second microdevice to react any non-reacted dextrose and/or dextrose oligomers with the acid catalyst at a temperature of at least 160° C. for a time sufficient to produce a second reacted composition wherein at least 90 weight % of the dextrose and/or dextrose oligomer have reacted, and wherein the second reacted composition comprises from 60 to 80 weight % dry solids; and
(h) refining the second reacted composition to form the resistant dextrin in liquid form.

17. The method of claim 16, wherein the method further comprises the step of;
(i) drying the resistant dextrin in liquid form to produce a partially dried resistant dextrin in liquid form;
wherein the partially dried resistant dextrin in liquid form comprises resistant dextrin at from 76 to 86 weight %; the balance at each weight % being essentially water.

18. A resistant dextrin in liquid form obtained by the method of claim 16.

19. A food product comprising the resistant dextrin in particulate form according to claim 1.

20. The food product of claim 19, wherein the resistant dextrin in particulate form is disposed in a phase of the food product having 10 weight % water or less;
wherein the resistant dextrin in particulate form and/or liquid form is dispersed in a lipid phase of a food matrix;
wherein the food product is a:
(a) chocolate; or,
(b) a confectionary composition; or,
(c) a chocolate filing; or,
(d) a cream filling;
or combinations thereof.
